(19) United States
(12) Patent Application Publication
(10) Pub. No.: US 2025/0048342 A1
(43) Pub. Date: Feb. 6, 2025

(54) NETWORK NODE IN COMMUNICATION SYSTEM AND METHOD PERFORMED BY THE SAME

(71) Applicant: Samsung Electronics Co., Ltd., Suwon-si (KR)

(72) Inventors: Fang XIE, Beijing (CN); Xinyan LI, Beijing (CN); Jianwei XU, Beijing (CN); Zhigang WANG, Beijing (CN); Nan CAO, Beijing (CN); Yunwei HUANG, Beijing (CN)

(21) Appl. No.: 18/912,090

(22) Filed: Oct. 10, 2024

Related U.S. Application Data
(63) Continuation of application No. PCT/KR2024/005557, filed on Apr. 24, 2024.

(30) Foreign Application Priority Data
Apr. 27, 2023 (CN) 202310477684.3
Feb. 8, 2024 (CN) 202410178160.9

(51) Int. Cl. H04W 72/0446; H04W 52/02; H04W 56/00; H04W 72/0453; H04W 72/566

(52) U.S. Cl. CPC H04W 72/0446; H04W 52/0235; H04W 56/0015; H04W 72/0453; H04W 72/566

(57) ABSTRACT

A method performed by a first network node in a communication system is provided. The method includes receiving, from one or more second network nodes, a first message related to each of the one or more second network nodes, the first message including information regarding an energy saving configuration of each of the one or more second network nodes, reconfiguring, based on the first message, time-frequency resources of at least one of the one or more second network nodes, and sending a second message to the at least one of the one or more second network nodes, the second message indicating the reconfigured time-frequency resources of the at least one of the one or more second network nodes.

### CROSS-REFERENCE TO RELATED APPLICATION(S)

This application is a continuation application, claiming priority under § 365(c), of an International application No. PCT/KR2024/005557, filed on Apr. 24, 2024, which is based on and claims the benefit of a Chinese patent application number 202310477684.3, filed on Apr. 27, 2023, in the Chinese Intellectual Property Office, and of a Chinese patent application number 202410178160.9, filed on Feb. 8, 2024, in the Chinese Intellectual Property Office, the disclosure of each of which is incorporated by reference herein in its entirety.

### TECHNICAL FIELD

The disclosure relates to the communication field. More particularly, the disclosure relates to a network node in a communication system (e.g., an open radio access network (O-RAN) based communication system) and a method performed by the same.

### BACKGROUND

The revolution of core networks of communication systems (e.g., 5th-Generation (5G) systems) is taking place. Radio access networks (e.g., 5G radio access networks) are characterized by high traffic, large bandwidth, high frequency band, and/or the like, which may result in smaller monostatic coverage, increased equipment complexity, and increased networking size, leading to large network cost and increased investment return risk. Considering the features and requirements of the radio access network, it is necessary to introduce new Information Technology (IT), Communication Technology (CT), Data Technology (DT) convergence development and design ideas in the radio access network, which is in keeping with the macroscopic evolution trend of the communication industry.

Based on this, operators are dominating the creation of an open radio access network (O-RAN) industrial alliance, presenting two core visions of “open” and “intelligence”, which are in line with the large development trend of the communication industry, and are another significant network revolution dominated by operators. The O-RAN alliance hopes to build an open intelligence wireless network with big data, machine learning (ML), and artificial intelligence (AI) technologies, while incorporating open standards, white-box hardware, and open-source software to reduce the wireless network cost.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a network node in a communication system (e.g., an open radio access network (O-RAN) based communication system) and a method performed by the same.

Additional aspects will be set forth in part in the description which follows and, in part, will be apparent from the description, or may be learned by practice of the presented embodiments.

In accordance with an aspect of the disclosure, a method performed by a first network node in a communication system is provided. The method includes receiving, from one or more second network nodes, a first message related to each of the one or more second network nodes, the first message including information regarding an energy saving configuration of each of the one or more second network nodes, reconfiguring, based on the first message, time-frequency resources of at least one of the one or more second network nodes, and sending a second message to the at least one of the one or more second network nodes, the second message indicating the reconfigured time-frequency resources of the at least one of the one or more second network nodes.

In combination with one or more aspects of the method performed by the first network node described above, for example, reconfiguring the time-frequency resources of the second network node based on the first message includes reconfiguring the time-frequency resources of the second network node in case that an energy saving mode of the second network node is a predetermined energy saving mode.

In combination with one or more aspects of the method performed by the first network node described above, for example, receiving the first message related to each of the second network nodes from the one or more second network nodes includes in case that an energy saving mode of the first network node is a predetermined energy saving mode and/or the first network node and the second network node are associated with a fourth network node, sending a third message to the one or more second network nodes, wherein the third message is used to instruct each of the one or more second network nodes to report the first message related to the second network node, and receiving, from the second network node, the first message related to the second network node.

In combination with one or more aspects of the method performed by the first network node described above, for example, the third message includes information indicating a period or a time interval for reconfiguring time-frequency resources of each of the one or more second network nodes, and/or the third message includes information indicating a period or a time interval for each of the one or more second network nodes to report the first message related to the second network node.

In connection with one or more aspects of the method performed by the first network node described above, for example, the energy saving mode of the first network node is configured by a third network node.

In combination with one or more aspects of the method performed by the first network node described above, for example, the third network node includes one or more of a non-real-time radio access network intelligence controller (Non-RT RIC) of a service management and orchestration (SMO) or a near-real-time radio access network intelligence controller (Near-RT RIC) of an open radio access network (O-RAN).

In combination with one or more aspects of the method performed by the first network node described above, for example, the predetermined energy saving mode includes an energy saving mode for a time unit, and wherein the time unit includes at least one of one or more symbols, one or more slots, one or more subframes, or one or more radio frames.

In combination with one or more aspects of the method performed by the first network node described above, for example, the predetermined energy saving mode includes an advanced sleep mode (ASM).

In combination with one or more aspects of the method performed by the first network node described above, for example, the information regarding the energy saving configuration includes at least one of information regarding an energy saving mode, information regarding a traffic priority of the second network node, information regarding a buffer occupancy (BO) per traffic type of the second network node, information regarding time-frequency resources of a remaining BO of the second network node, information regarding time-frequency resources of a reference signal of the second network node, or information regarding a bandwidth of the second network node.

In combination with one or more aspects of the method performed by the first network node described above, for example, the information regarding the time-frequency resources of the reference signal of the second network node includes a time-frequency resource bitmap of a first reference signal of the second network node, and a time-frequency resource bitmap of a second reference signal of the second network node within each period or each time interval, and the information regarding the BO per traffic type of the second network node includes information regarding a BO per traffic type of the second network node within each period or each time interval.

In combination with one or more aspects of the method performed by the first network node described above, for example, the first reference signal includes a synchronization signal block (SSB), and the second reference signal includes a channel state information reference signal (CSI-RS).

In combination with one or more aspects of the method performed by the first network node described above, for example, reconfiguring the time-frequency resources of the at least one of the one or more second network nodes including reconfiguring the time-frequency resources of the at least one of the one or more second network nodes based on at least one of No change for time-frequency resources of the reference signal, Reconfiguring time-frequency resources is limited by maximum bandwidth of the second network node, minimizing a time-domain resource occupancy, ensuring a transmission of a higher priority traffic preferentially over a lower priority traffic, or reconfiguring time-frequency resources for a lower priority traffic preferentially over a higher priority traffic.

In combination with one or more aspects of the method performed by the first network node described above, for example, the method further includes receiving a response message from the at least one second network node indicating whether the reconfiguring of the time-frequency resources is successful.

In combination with one or more aspects of the method performed by the first network node described above, for example, the first network node includes a host O-RAN distribution unit (O-DU), and the second network node includes a slave O-DU, wherein the host O-DU and the slave O-DU are associated with a same O-RAN radio unit (O-RU).

In combination with one or more aspects of the method performed by the first network node described above, for example, the host O-DU and the slave O-DU being associated with the same O-RU includes that the host O-DU and the slave O-DU share a same carrier of a same O-RU, and/or the host O-DU and the slave O-DU share different carriers of a same O-RU.

In combination with one or more aspects of the method performed by the first network node described above, for example, further including sending, to a fourth network node associated with the first network node and the second network node, an energy saving configuration including information indicating one or more time units that are switched off, wherein the time unit includes at least one of one or more symbols, one or more slots, one or more subframes, or one or more radio frames.

In connection with one or more aspects of the method performed by the first network node described above, for example, the first network node includes a host O-DU, and/or the second network node includes a slave O-DU, and/or the fourth network node includes an O-RU.

In accordance with aspect of the disclosure, a method performed by a second network node in a communication system is provided. The method includes sending, to a first network node, a first message related to a second network node, the first message including information regarding an energy saving configuration of the second network node, and receiving a second message transmitted by the first network node, the second message indicating reconfigured time-frequency resources of the second network node.

In combination with one or more aspects of the method performed by the second network node described above, for example, the method further includes receiving a third message transmitted by the first network node, wherein the third message is used to instruct the second network node to report the first message related to the second network node, sending, to the first network node, the first message related to the second network node.

In combination with one or more aspects of the method performed by the second network node described above, for example, the third message includes information indicating a period or a time interval for reconfiguring time-frequency resources of each of one or more second network nodes, and/or the third message includes information indicating a period or a time interval for each of the one or more second network nodes to report the first message related to the second network node.

In combination with one or more aspects of the method performed by the second network node described above, for example, sending the first message related to the second network node to the first network node includes sending the first message related to the second network node to the first network node based on the period or the time interval included in the third message.

In combination with one or more aspects of the method performed by the second network node described above, for example, the information regarding the energy saving configuration includes at least one of information regarding an energy saving mode, information regarding a traffic priority of the second network node, information regarding a buffer occupancy (BO) per traffic type of the second network node, information regarding time-frequency resources of a remaining BO of the second network node, information regarding time-frequency resources of a reference signal of the second network node, or information regarding a bandwidth of the second network node.

In combination with one or more aspects of the method performed by the second network node described above, for example, the information regarding the time-frequency resources of the reference signal of the second network node includes a time-frequency resource bitmap of a first reference signal of the second network node, and a time-frequency resource bitmap of a second reference signal of the second network node within each period or each time interval, and the information regarding the BO per traffic type of the second network node includes information regarding a BO per traffic type of the second network node within each period or each time interval.

In combination with one or more aspects of the method performed by the second network node described above, for example, the first reference signal includes synchronization signal block (SSB), and the second reference signal includes channel state information reference signal (CSI-RS).

In combination with one or more aspects of the method performed by the second network node described above, for example, the method further includes reconfiguring the time-frequency resources based on the second message.

In combination with one or more aspects of the method performed by the second network node described above, for example, the method further includes sending a response message to the first network node indicating whether the reconfiguring if the time-frequency resources is successful.

In combination with one or more aspects of the method performed by the second network node described above, for example, the first network node includes a host O-RAN distribution unit (O-DU), and the second network node includes a slave O-DU, wherein the host O-DU and the slave O-DU are associated with a same O-RAN radio unit (O-RU).

In combination with one or more aspects of the method performed by the second network node described above, for example, the host O-DU and the slave O-DU being associated with the same O-RU includes that the host O-DU and the slave O-DU share a same carrier of a same O-RU, and/or the host O-DU and the slave O-DU share different carriers of a same O-RU.

In accordance with aspect of the disclosure, a method performed by a third network node in a communication system is provided. The method includes obtaining information related to network energy saving, and determining, for at least one fifth network node, an energy saving mode from among one or more energy saving modes based on the information related to network energy saving, wherein the determined energy saving mode is used to determine an energy saving configuration of the fifth network node.

In combination with one or more aspects of the method performed by the third network node described above, for example, the information related to network energy saving includes one or more of information regarding a user equipment (UE), information regarding a fourth network node, or information regarding a fifth network node.

In combination with one or more aspects of the method performed by the third network node, for example, obtaining the information related to network energy saving includes receiving the information related to network energy saving by a collection and control module.

In combination with one or more aspects of the method performed by the third network node described above, for example, the information related to network energy saving includes one or more of information regarding a UE, information regarding a fourth network node, or information regarding a fifth network node, wherein the information regarding the UE is received by the collection and control module from an external server, wherein the information regarding the fourth network node is received by the collection and control module from the fourth network node, and wherein the information regarding the fifth network node is received by the collection and control module from the fifth network node.

In combination with one or more aspects of the method performed by the third network node described above, for example, the information regarding the UE includes one or more of information regarding a mobility of the UE, or information regarding a traffic load of the UE, and/or the information regarding the fourth network node includes one or more of information regarding an energy consumption of one or more hardware components of the fourth network node, information regarding a transmit power of the fourth network node, information regarding a type of the fourth network node, identification information of one or more fifth network nodes associated with the fourth network node, or information regarding a power amplifier bias level supported by the fourth network node, and/or the information regarding the fifth network node includes one or more of information regarding a cell uplink and/or downlink data flow, information regarding measurement of a downlink reference signal, information regarding a number of UEs in connected state, information regarding an inter-cell interference, information regarding an inter-UE interference measurement, information regarding a UE load, information regarding a cell load, information regarding an air interface energy efficiency of the fourth network node, information regarding a cell uplink and/or downlink resource configuration, information regarding a cell uplink and/or downlink bit error rate and/or retransmission rate, information regarding a multiple-input multiple-output (MIMO) related measurement, or information regarding an interference between fifth network nodes.

In combination with one or more aspects of the method performed by the third network node described above, for example, the type of the fourth network node includes a shared fourth network node sharing a carrier, a shared fourth network node of different carriers, or a separate fourth network node.

In combination with one or more aspects of the method performed by the third network node described above, for example, the fourth network node includes an open radio access network (O-RAN) radio unit (O-RU), and/or the fifth network node includes an E2 node or an O-RAN distribution unit (O-DU).

In connection with one or more aspects of the method performed by the third network node described above, for example, predicted energy saving modes of the one or more O-DUs do not conflict with each other.

In combination with one or more aspects of the method performed by the third network node described above, for example, determining the energy saving mode includes predicting the energy saving mode for the at least one fifth network node based on the information related to network energy saving by using a trained first AI model.

In combination with one or more aspects of the method performed by the third network node described above, for example, the method further includes determining a UE traffic load based on the information related to network energy saving, and sending information indicating the UE traffic load.

In combination with one or more aspects of the method performed by the third network node described above, for example, sending the information indicating the UE traffic load includes sending the information indicating the UE traffic load to one or more of a fourth network node or a fifth network node, so that the one or more of the fourth network node or the fifth network node determine an energy saving configuration to apply.

In combination with one or more aspects of the method performed by the third network node described above, for example, determining the UE traffic load based on the information related to network energy saving includes predicting the UE traffic load for the at least one fifth network node based on the information related to network energy saving by using a trained first AI model.

In combination with one or more aspects of the method performed by the third network node described above, for example, the first AI model is trained by the third network node using the information related to network energy saving, or is received from another network node.

In combination with one or more aspects of the method performed by the third network node described above, for example, the one or more energy saving modes includes one or more of a first energy saving mode where a carrier and cell is switched on/off, a second energy saving mode where RF channel reconfiguration is on/off, a third energy saving mode where an advanced sleep mode (ASM) is selected, or a fourth energy saving mode where a power amplifier bias value is changed.

In combination with one or more aspects of the method performed by the third network node described above, for example, the method further includes determining an energy saving configuration corresponding to the energy saving mode based on the information related to network energy saving, and/or sending information indicating the energy saving configuration corresponding to the energy saving mode to one or more of a fourth network node or a fifth network node.

In combination with one or more aspects of the method performed by the third network node described above, for example, the method further includes sending information indicating the energy saving mode to another network node, so that the another network node determines an energy saving configuration corresponding to the energy saving mode, wherein the information indicating the energy saving configuration is sent by the another network node to one or more of a fourth network node or a fifth network node.

In combination with one or more aspects of the method performed by the third network node described above, for example, the third network node includes one or more of a non-real-time radio access network intelligence controller (Non-RT RIC) of a service management and orchestration (SMO) or a near-real-time radio access network intelligence controller (Near-RT RIC) of an O-RAN.

In accordance with aspect of the disclosure, a first network node in a communication system is provided. The first network node includes a transceiver, one or more processors coupled to the transceiver, and memory coupled with the one or more processors and storing one or more computer programs including computer-executable instructions that, when executed by the one or more processors of the first network node, cause the first network node to receive, from one or more second network nodes, a first message related to each of the second network nodes, the first message including information regarding an energy saving configuration of the second network node, reconfigure, based on the first message, time-frequency resources of at least one of the one or more second network nodes, and send a second message to the at least one of the one or more second network nodes, the second message indicating the reconfigured time-frequency resources of the at least one of the one or more second network nodes.

In accordance with aspect of the disclosure, a second network node in a communication system is provided. The second network node includes a transceiver, one or more processors coupled to the transceiver, and memory coupled with the one or more processors and storing one or more computer programs including computer-executable instructions that, when executed by the one or more processors of the second network node, cause the second network node to send, to a first network node, a first message related to a second network node, the first message including information regarding an energy saving configuration of the second network node, and receive a second message transmitted by the first network node, the second message indicating reconfigured time-frequency resources of the second network node.

In accordance with aspect of the disclosure, a third network node in a communication system is provided. The third network node includes one or more processors, and memory coupled with the one or more processors and storing instructions that, when executed by the one or more processors of the network node, cause the network node to perform one or more operations of the three network node-performed method described above.

In accordance with aspect of the disclosure, one or more non-transitory computer-readable storage media storing one or more computer programs including computer-executable instructions that, when executed by one or more processors of a first network node, cause the first network node to perform operations are provided. The operations include receiving, from one or more second network nodes, a first message related to each of the one or more second network nodes, the first message including information regarding an energy saving configuration of each of the one or more second network nodes, reconfiguring, based on the first message, time-frequency resources of at least one of the one or more second network nodes, and sending a second message to the at least one of the one or more second network nodes, the second message indicating the reconfigured time-frequency resources of the at least one of the one or more second network nodes.

In accordance with aspect of the disclosure, one or more non-transitory computer-readable storage media storing one or more computer programs including computer-executable instructions that, when executed by one or more processors of a second network node, cause the second network node to perform operations are provided. The operations include sending, to a first network node, a first message related to a second network node, the first message including information regarding an energy saving configuration of the second network node, and receiving a second message transmitted by the first network node, the second message indicating reconfigured time-frequency resources of the second network node.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1A illustrates an O-RAN based energy saving architecture according to an embodiment of the disclosure;

FIG. 1B illustrates an ORAN-based shared O-RU structure according to an embodiment of the disclosure;

FIG. 1C illustrates an energy saving architecture under an O-RAN based shared O-RU structure, according to an embodiment of the disclosure;

FIG. 1D illustrates an overall architecture of an O-RAN based communication system according to an embodiment of the disclosure;

FIG. 1E illustrates a flow diagram of selection of an energy saving mode and determination of a corresponding configuration in an O-RAN energy saving scheme (Near-RT RIC deployment), according to an embodiment of the disclosure;

FIG. 2 illustrates a flow diagram of selection of an energy saving mode and determination of a corresponding configuration in an O-RAN energy saving scheme (Non-RT RIC deployment), according to an embodiment of the disclosure;

FIG. 3 illustrates a flow diagram of radio frequency (RF) power amplifier (PA) bias control and determination of a corresponding configuration in an O-RAN energy saving scheme (Non-RT RIC deployment), according to an embodiment of the disclosure;

FIG. 4 illustrates a flow diagram of PA bias control and determination of a corresponding configuration in an O-RAN energy saving scheme (Near-RT RIC deployment), according to an embodiment of the disclosure;

FIG. 5 illustrates a flow diagram of an energy saving method of carrier/cell switch off/on and determination of a corresponding configuration in an O-RAN energy saving scheme (Non-RT RIC deployment), according to an embodiment of the disclosure;

FIG. 6 illustrates a flow diagram of an energy saving method of carrier/cell switch off/on and determination of a corresponding configuration in an O-RAN energy saving scheme (Near-RT RIC deployment), according to an embodiment of the disclosure;

FIG. 7 illustrates a flow diagram of a method of RF channel reconfiguration in an O-RAN energy saving scheme (Non-RT RIC deployment), according to an embodiment of the disclosure;

FIG. 8 illustrates a flow diagram of determination of an energy saving method of RF channel reconfiguration in an O-RAN energy saving scheme (Near-RT RIC deployment), according to an embodiment of the disclosure;

FIG. 9 illustrates a flow diagram of an energy saving method of an advanced sleep mode (ASM) and determination of a corresponding configuration in an O-RAN energy saving scheme (Non-RT RIC deployment), according to an embodiment of the disclosure;

FIG. 10 illustrates a flow diagram of an energy saving method of the ASM and determination of a corresponding configuration in an O-RAN energy saving scheme (Near-RT RIC deployment), according to an embodiment of the disclosure;

FIGS. 11A and 11B illustrate schematic diagrams of interferences between multiple O-DUs in an O-RAN energy saving scheme and the impact of the interferences on energy saving configurations, according to various embodiment of the disclosure;

FIG. 12 illustrates an example of conflicting energy saving modes under shared O-RU structure in an O-RAN energy saving scheme, according to an embodiment of the disclosure;

FIG. 13 illustrates an example of an inefficient energy saving configuration under shared carrier in shared O-RU structure in an O-RAN energy saving scheme, according to an embodiment of the disclosure;

FIG. 14 illustrates a determination flow of a configuration of an energy saving scheme in an O-RAN architecture (Non-RT RIC/Near-RT RIC deployment), according to an embodiment of the disclosure;

FIG. 15 illustrates a flow diagram of energy saving mode determination in a multi-O-DU scenario or a non-conflicting energy saving mode in a shared O-RU scenario in an O-RAN energy saving scheme (Non RIC/Near-RT RIC deployment), according to an embodiment of the disclosure;

FIG. 16 illustrates an example of an inefficient energy saving configuration under shared carrier in shared O-RU structure in an O-RAN energy saving scheme, according to an embodiment of the disclosure;

FIG. 17 illustrates a flow diagram of a method of resource reconfiguration by a host O-DU under shared carrier in shared O-RU structure in an O-RAN energy saving scheme, according to an embodiment of the disclosure;

FIG. 18 illustrates a flow diagram of a method of resource reconfiguration by a host O-DU under shared O-RU structure in an O-RAN energy saving scheme, according to an embodiment of the disclosure;

FIGS. 19A, 19B, and 19C illustrate examples of a method of time-frequency resource reconfiguration by a host O-DU under shared carrier in shared O-RU structure for O-RAN, according to various embodiments of the disclosure;

FIG. 20 illustrates a flow diagram of a method performed by a network node according to an embodiment of the disclosure;

FIG. 21 illustrates a flow diagram of a method performed by a network node according to an embodiment of the disclosure;

FIG. 22 illustrates a flow diagram of a method performed by a first network node according to an embodiment of the disclosure;

FIG. 23 illustrates a flow diagram of a method performed by a second network node according to an embodiment of the disclosure;

FIG. 24 illustrates a flow diagram of a method performed by a third network node according to an embodiment of the disclosure; and

FIG. 25 illustrates a block diagram of a configuration of an apparatus according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Before undertaking the DETAILED DESCRIPTION below, it can be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, connect to, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller can be implemented in hardware or a combination of hardware and software and/or firmware. The functionality associated with any particular controller can be centralized or distributed, whether locally or remotely. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C. For example, “at least one of: A, B, or C” includes any of the following combinations: A, B, C, A and B, A and C, B and C, and A, B and C.

Moreover, various functions described below can be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as Read-Only Memory (ROM), Random Access Memory (RAM), a hard disk drive, a Compact Disc (CD), a Digital Video Disc (DVD), or any other type of memory. A “non-transitory” computer-readable medium excludes wired, wireless, optical, or other communication links that transport transitory electrical or other signals. A non-transitory computer-readable medium includes media where data can be permanently stored and media where data can be stored and later overwritten, such as a rewritable optical disc or an erasable memory device.

Terms used herein to describe the embodiments of the disclosure are not intended to limit and/or define the scope of the disclosure. For example, unless otherwise defined, the technical terms or scientific terms used in the disclosure shall have the ordinary meaning understood by those with ordinary skills in the art to which the disclosure belongs.

It should be understood that “first”, “second” and similar words used in the disclosure do not express any order, quantity or importance, but are only used to distinguish different components. For example, reference to “a component surface” includes reference to one or more of such surfaces.

As used herein, any reference to “an example” or “example”, “an implementation” or “implementation”, “an embodiment” or “embodiment” means that particular elements, features, structures or characteristics described in connection with the embodiment is included in at least one embodiment. The phrases “in one embodiment” or “in one example” appearing in different places in the specification do not necessarily refer to the same embodiment.

As used herein, “a portion of” something means “at least some of” the thing, and as such may mean less than all of, or all of, the thing. As such, “a portion of” a thing includes the entire thing as a special case, i.e., the entire thing is an example of a portion of the thing.

As used herein, the term “set” may mean one or more. Accordingly, a set of items can be a single item or a collection of two or more items.

In the disclosure, to determine whether a specific condition is satisfied or fulfilled, expressions, such as “greater than/larger than” or “less than/smaller than” are used by way of example and expressions, such as “greater than or equal to” or “less than or equal to” are also applicable and not excluded. For example, a condition defined with “greater than or equal to” may be replaced by “greater than” (or vice-versa), a condition defined with “less than or equal to” may be replaced by “less than” (or vice-versa), etc.

It will be further understood that similar words such as the term “include” or “comprise” mean that elements or objects appearing before the word encompass the listed elements or objects appearing after the word and their equivalents, but other elements or objects are not excluded. Similar words such as “connect” or “connected” are not limited to physical or mechanical connection, but can include electrical connection, whether direct or indirect. “Upper”, “lower”, “left” and “right” are only used to express a relative positional relationship, and when an absolute position of the described object changes, the relative positional relationship may change accordingly.

The various embodiments discussed below for describing the principles of the disclosure in the patent document are for illustration only and should not be interpreted as limiting the scope of the disclosure in any way. Those skilled in the art will understand that the principles of the disclosure can be implemented in any suitably arranged wireless communication system.

Herein, depending on the network type, the term “base station” or “BS” can refer to any component (or a set of components) configured to provide wireless access to a network, such as a Transmission Point (TP), a Transmission and Reception Point (TRP), an evolved base station (eNodeB or eNB), a 5G base station (gNB), a macrocell, a femtocell, a WiFi access point (AP), or other wireless network devices. Base stations may provide wireless access in accordance with one or more wireless communication protocols, e.g., 5G 3rd Generation Partnership Project (3GPP) new radio (NR) interface/access, Long Term Evolution (LTE), LTE advanced (LTE-A), High Speed Packet Access (HSPA), Wi-Fi 802.11a/b/g/n/ac, etc. Those skilled in the art will understand that, “terminal” and “terminal device” as used herein include not only devices with wireless signal receiver which have no transmitting capability, but also devices with receiving and transmitting hardware which can carry out bidirectional communication on a bidirectional communication link. Such devices may include cellular or other communication devices with single-line displays or multi-line displays or cellular or other communication devices without multi-line displays; a personal communications service (PCS), which may combine voice, data processing, fax and/or data communication capabilities; a Personal Digital Assistant (PDA), which may include a radio frequency (RF) receiver, a pager, an internet/intranet access, a web browser, a notepad, a calendar and/or a Global Positioning System (GPS) receiver; a conventional laptop and/or palmtop computer or other devices having and/or including a radio frequency receiver. “Terminal” and “terminal device” as used herein may be portable, transportable, installed in vehicles (aviation, sea transportation and/or land), or suitable and/or configured to operate locally, and/or in distributed form, operate on the earth and/or any other position in space. “Terminal” and “terminal device” as used herein may also be a communication terminal, an internet terminal, a music/video playing terminal, such as a PDA, a Mobile Internet Device (MID) and/or a mobile phone with music/video playing functions, a smart TV, a set-top box and other devices.

In this disclosure, various embodiments will be described using terminology employed in some communication standards, such as 3rd Generation Partnership Project (3GPP) and Open Radio Access Network (O-RAN), but these embodiments are for illustration purposes only. The embodiments of the disclosure may also be easily applied to other communication systems through modifications.

Herein, the terms “user”, “user equipment (UE)”, and “terminal” may be used interchangeably unless otherwise indicated. In addition, the terms “base station” and “cell” may be used interchangeably unless otherwise indicated.

Herein, an E2 node may be one of a next generation Node B (gNB), a distribution unit (DU), an evolved Node B (eNB), a gNB control unit (gNB-CU), an en-gNB, and an ng-eNB.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

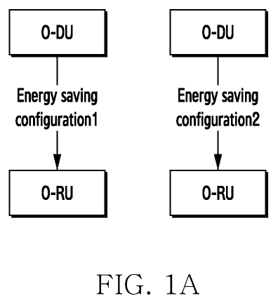

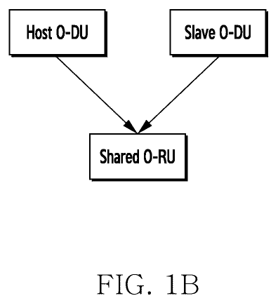

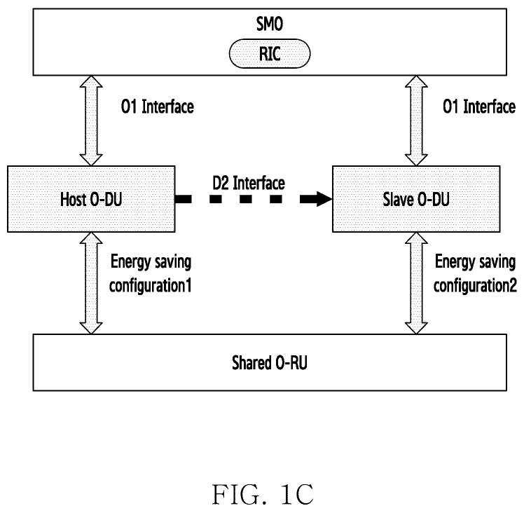

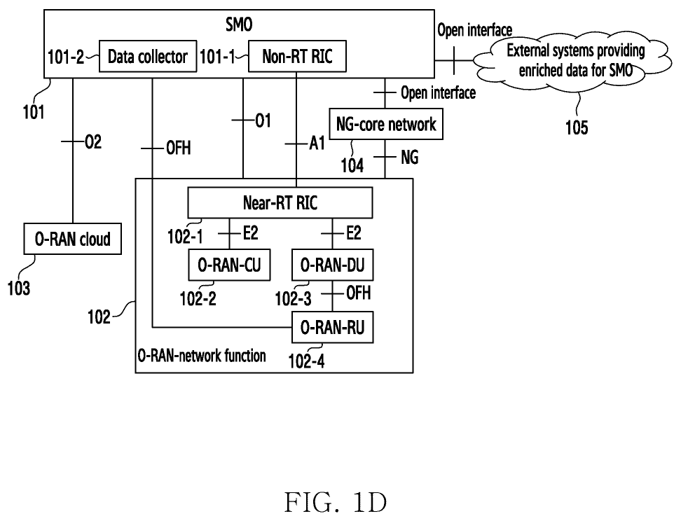

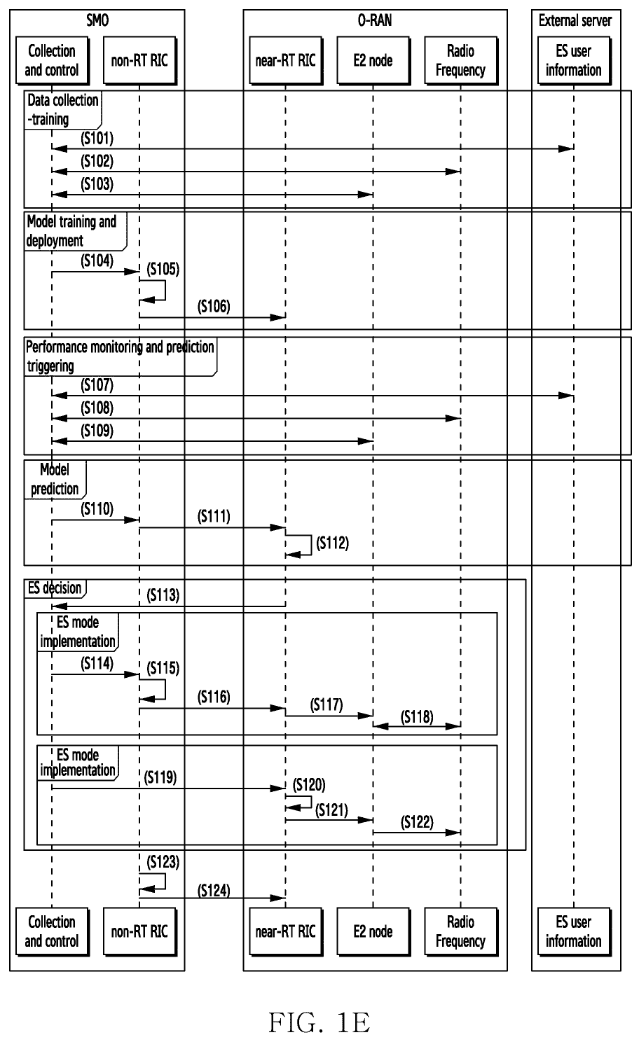

FIG. 1A illustrates an O-RAN based energy saving architecture according to an embodiment of the disclosure.

Energy/power saving is an important technology for operators. Referring to FIG. 1A, in the O-RAN architecture, each O-RU (O-RAN Radio Unit) performs an energy saving operation after receiving an energy saving configuration sent by an O-DU (O-RAN Distributed Unit) to save energy.

FIG. 1B illustrates an ORAN-based shared O-RU structure according to an embodiment of the disclosure.

Meanwhile, the O-RAN Alliance proposes a shared O-RU structure, referring to FIG. 1B, to further reduce the network deployment cost while increase the capacity and coverage of network by sharing resources of one O-RU by multiple operators or multiple O-DUs. The shared O-RU is one of the key technologies for O-RAN. In the shared O-RU structure, an O-RU shall be configured to operate with multiple O-DUs of same or different operators. The one or more O-DUs include a host O-DU. The host O-DU determines how the resources of the shared O-RU are partitioned between multiple O-DUs. The remaining O-DUs other than the host O-DU are referred to as slave O-DUs. In the shared O-RU structure, multiple O-DUs control the same O-RU and shared the antenna resources. Under shared carrier in shared O-RU structure, multiple O-DUs share time-frequency resources, and a host O-DU and a slave O-DU may simultaneously configure energy saving mode for the shared O-RU.

FIG. 1C illustrates an energy saving architecture under an O-RAN based shared O-RU structure, according to an embodiment of the disclosure.

Low energy saving efficiency is a problem that must be considered. There are two main reasons for low energy saving efficiency. Reason 1: referring to FIG. 1C, under shared carrier in shared O-RU structure, since all O-DUs configure their own energy saving (ES) modes independently of the rest of O-DUs, and all O-DUs share time-frequency resources. The shared O-RU is likely to receive conflicting energy saving slot configurations from host O-DU and slave O-DU, resulting in reduced energy saving efficiency. Reason 2: RIC train ES AI model energy saving AI model without considering shared O-RU structure and interference among the O-DUs. Also current large time granularity of the energy saving mode is large, the RIC may recommend an inaccurate energy saving mode for the O-DU, resulting in low energy saving efficiency.

Some aspects of the disclosure relate to a method for energy saving in an O-RAN based communication system. The method can configure respective energy saving policies for an E2 node and an O-RU under different scenarios by measuring and/or predicting network load, user traffic load, traffic type, and/or mobility, and comprehensively considering an energy saving capability of hardware components of base station system (e.g., the E2 node and the O-RU), thereby achieving the effect of reducing energy consumption of the base station system and improving energy utilization of the base station system.

According to an aspect of the disclosure, a method for energy saving performance optimization in an O-RAN based communication system may include: requesting report of information via an interface between a network management entity (e.g., an SMO entity, and/or collection and control in an SMO entity) and a network function (e.g., an E2 node) or via an interface within a network function; receiving the reported information and generating policy information based on the reported information; and sending the policy information via a corresponding interface. The report of the information may include report of information related to network energy saving. The policy information may indicate an energy saving policy.

According to an aspect of the disclosure, the different energy saving policies may correspond to a determined energy saving mode, where the determined energy saving mode may include one of: an energy saving mode of carrier/cell switch off/on; an energy saving mode of radio frequency (RF) channel reconfiguration; selection of an advanced sleep mode; or PA bias control.

According to an aspect of the disclosure, receiving the reported information may include at least one of: receiving user load information via a corresponding interface; receiving cell load information via a corresponding interface; receiving strength information and configuration information of a reference signal (e.g., CSI-RS or SSB) via a corresponding interface; receiving energy consumption information of hardware components of the base station system (e.g., E2 node and/or O-RU) via a corresponding interface; receiving information of an energy saving capability of an O-RU and/or a PA bias level supported by the O-RU via a corresponding interface; receiving an O-RU type and identification information of all O-DUs controlling the O-RU via a corresponding interface; receiving inter-cell interference information via a corresponding interface; receiving information regarding interferences among the O-DUs via a corresponding interface.

According to an aspect of the disclosure, the method may further include receiving information regarding a user (e.g., a user scenario) (e.g., a terminal) from an external server, where the information regarding the user scenario may include at least one of: information regarding a mobility of the user; and information regarding a traffic load of the user. The information regarding the mobility of the user may be used for estimation and prediction of the mobility for each user in each cell. The information regarding the traffic load of the user may be used for estimation and prediction of the traffic load for each user in each cell.

According to an aspect of the disclosure, receiving the reported information and generating the policy information based on the reported information may further include generating the policy information by using an Artificial Intelligence/Machine Learning (AI/ML) model based on the collected information regarding the user scenario and/or measured information regarding energy saving characteristics (of all energy saving modes) and/or information reported by all O-DUs/O-RUs.

According to an aspect of the disclosure, the policy information may include at least one of: a selection of an energy saving mode; configuration information corresponding to an energy saving mode. The configuration information may include base station system level configuration information and/or user level configuration information.

According to an aspect of the disclosure, the method may further include determining and sending configuration information (e.g., configuration parameters) and/or RRC reconfiguration information of E2 node(s) and/or O-RU(s) based on the generated policy information.

According to an aspect of the disclosure, an intelligent controller for decision may be deployed in one entity (e.g., function), or deployed in multiple entities (e.g., functions) and connected via interfaces.

According to an aspect of the disclosure, based on a deployment manner of an intelligent controller for decision and the generated policy information, corresponding information may be increased on corresponding interfaces, an interface for receiving the policy information may be determined.

According to an aspect of the disclosure, a method for energy saving performance optimization in an O-RAN based communication system includes: requesting report of information via an interface between a network management entity and a network function or an interface within the network function; receiving reported information and generating prediction information based on the reported information; and sending the prediction information via a corresponding interface, where the prediction information is used by a base station to determine a configuration of the E2 node and the O-RU.

According to an aspect of the disclosure, receiving the reported information may include receiving information regarding a user scenario from an external server, where the information regarding the user scenario includes at least one of: information regarding a mobility of the user; and information regarding a traffic load of the user. The information regarding the mobility of the user may be used for estimation and prediction of the mobility for each user in each cell. The information regarding the traffic load of the user may be used for estimation and prediction of the traffic load for each user in each cell.

According to an aspect of the disclosure, the prediction information may include at least one of: prediction information of the mobility of the user; and prediction information of the traffic load of the user.

According to an aspect of the disclosure, receiving the reported information and generating the prediction information based on the reported information further includes generate the prediction information based on the collected information regarding the user scenario by using an Artificial Intelligence/Machine Learning (AI/ML) model.

According to an aspect of the disclosure, the method further includes determining and sending RRC configuration parameters based on the prediction information sent by the base station.

According to an aspect of the disclosure, an intelligent controller for prediction is deployed in one entity (e.g., function) or deployed in multiple entities (e.g., functions) and connected via interfaces.

According to an aspect of the disclosure, based on a deployment manner of the intelligent controller for prediction and the generated prediction information, corresponding information is increased on corresponding interfaces and an interface for receiving the prediction information is determined.

According to an aspect of the disclosure, receiving the reported information and generating the prediction information based on the reported information further includes receiving a prediction feedback from the base station to update the prediction information.

According to an aspect of the disclosure, in a shared O-RU structure, a Non-RT RIC/Near-RT RIC generates non-conflicting energy saving modes based on the reported information of all O-DUs and configures the non-conflicting energy saving modes to all O-DUs sharing one O-RU.

According to an aspect of the disclosure, in a shared O-RU structure, all O-DUs may predict a time-frequency resource configuration according to a predicted traffic load, and/or the like.

According to an aspect of the disclosure, a D2 interface is used to define a network interface among the O-DUs for transferring information among the O-DUs.

According to an aspect of the disclosure, under shared carrier in shared O-RU structure, slave O-DU may report energy saving mode, remaining BO, bandwidth limit, traffic priority, time-frequency resource bitmap/pattern of the remaining BO and time-frequency resource bitmap/pattern of reference signal, and/or the like.

According to an aspect of the disclosure, under shared carrier in shared O-RU structure, if an energy saving mode recommended by a Non-RT RIC/Near-RT RIC to a host O-DU is an ASM, the host O-DU may reconfigure time-frequency resources of all O-DUs sharing one O-RU based on information reported by all slave O-DUs to maximize energy saving efficiency. In an embodiment of the disclosure, the ASM mode may refer to an energy saving mode for a time unit. For example, the ASM energy saving mode may refer to a mode of sleeping or in an inactive state (e.g., in which no signals are transmitted and/or received) in one or more time units (e.g., slots and/or symbols). According to an aspect of the disclosure, a O-RAN based communication system includes: a network management entity configured to request report of information via an interface between the network management entity and a network function or via an interface between network functions; a RAN intelligent controller, including a Non-RT RIC and a Near-RT RIC, configured to generate policy information or prediction information based on the reported information, and send the policy information or prediction information via a corresponding interface; and a base station configured to determine a transmission mode for a user according to the policy information and the prediction information.

According to an aspect of the disclosure, an O-RAN based communication apparatus includes memory and a processor. The memory has instructions stored thereon that when executed by the processor implement the aforementioned method.

Example embodiments of the disclosure are described in detail below in conjunction with the accompanying drawings.

FIG. 1D illustrates an overall architecture of an O-RAN based communication system according to an embodiment of the disclosure.

The overall architecture of the O-RAN based communication system is built on the Centralized Unit (CU)/Distributed Unit (DU) architecture and functional virtualization of a radio access network (e.g., base station), introducing a reference design of open interfaces and open hardware, while optimizing wireless control flows with artificial intelligence.

Referring to FIG. 1D, the overall architecture of the O-RAN based communication system may include a Service Management and Orchestration (SMO) entity 101, a Non-RT RIC 101-1, a data collector, an O-RAN network function entity 102, an O-RAN Cloud (O-Cloud) 103, a core network 104, and an external system 105. The O-RAN network function entity 102 may include a Near-Real Time RAN Intelligent Controller (Near-RT RIC) 102-1, an O-RAN-CU (O-CU) 102-2, and an O-RAN-DU (O-DU) 102-3. The O-CU 102-2 may include an O-CU-control plane (CP) and an O-CU-user plane (UP). The overall architecture of the O-RAN based communication system in FIG. 1D is only an example, and some entities may be omitted or some new entities may be added.

The SMO entity is an entity for providing a variety of management services and network management functions. The SMO entity 101 may include a Non-RT RIC 101-1 and a data collector (may also be referred to as collection and control) 101-2.

Non-RT RIC 101-1: Non-RT RIC 101-1 has functions such as microservice and policy management, wireless network analysis, and/or training of Artificial Intelligence (AI)/Machine Learning (ML) models. The trained AI model may be directly deployed at the Non-RT RIC, or sent and deployed at the Near-Real Time RAN Intelligent Controller 102-1 (Near-RT RIC) via an A1 interface for inference.

The data collector 101-2 is a functional entity in the SMO entity 101 for collecting internal data and external data (the data collector does not refer to an O-RAN specific entity, but to a functional entity with the ability to collect internal and external data).

In contrast to network function entities in non-O-RAN based communication systems, the Near-RT RIC 102-1 is introduced in the O-RAN network function entity 102. The entities or functions involved in the present application in the internal functional node of the O-RAN network function entity also include an O-CU and an O-DU.

Through near-real-time data collection and processing, the Near-RT RIC 102-1 enables near-real-time control and optimization of radio resources. It may include training, inference, and/or updating of an AI/ML model.

The O-CU 102-2 carries logical nodes of RRC and PDCP protocol control plane portions. The O-CU 102-2 has increased support for an E2 interface compared to CUs of non-O-RAN based communication systems.

The O-DU 102-3 carries logical nodes of RLC/MAC/High-PHY layers. The O-DU has increased support for the E2 interface compared to DUs of non-O-RAN based communication systems.

O-RAN Cloud 103 (O-Cloud): O-Cloud 103 is a cloud computing platform that consists of a set of physical infrastructure nodes that meet O-RAN requirements to carry related O-RAN functions (such as Near-RT RIC, O-CU, and O-DU), support software components (such as operating systems, virtual machine monitors, container runtimes, etc.), and appropriate management and orchestration functions.

The core network 104 (e.g., 5G core network), for example, is used to realize mobility management and session management.

The external system 105 may include a server including various types of applications (APPs) and/or the like, providing enriched data for the SMO entity.

The overall architecture of the O-RAN based communication system further includes the following interfaces for communication between the above entities:
O1 interface: the O1 interface is used to connect the SMO entity 101 and the functional entities in the O-RAN network function entity 102 (the connection in the figure is only schematic, the O1 interface and each functional entity in the O-RAN network function entity 102 are connected);
O2 interface: the O2 interface is used to connect the SMO entity 101 and the O-Cloud 103;
A1 interface: the A1 interface is used to connect the Non-RT RIC 101-1 in the SMO entity 101 and the Near-RT RIC 102-1 in the O-RAN network function entity 102. The A1 interface uses the A1 policy, which is created, modified and deleted by the Non-RT RIC 101-1 in the SMO entity 101, to direct the Near-RT RIC 102-1, thereby enabling the O-RAN network function entity 102 to better implement functions such as radio resource management. Data information from the Non-RT RIC 101-1 may be transmitted to the Near-RT RIC 102-1 via the A1 interface. Also, feedback information from the Near-RT RIC 102-1 may be transmitted to the Non-RT RIC 101-1 via the A1 interface, so that the Non-RT RIC 101-1 can monitor the usage of the A1 policy.
E2 interface: the E2 interface is used to connect the Near-RT RIC 102-1 and the O-CU 102-2, and connect the Near-RT RIC 102-1 and the O-DU 102-3. The Near-RT RIC 102-1 may not only collect measurement information of the O-RAN network function entity 102, but may also send control commands to the base station via the E2 interface.

The OFH interface is a standard interface between the O-RU 102-4 and the O-DU 102-3, as well as the SMO 101. The OFH interface supports not only the management of the O-RU 102-4 by the O-DU 102-3 and the SMO 101, but also the Fault, Configuration, Accounting, Performance and Security (FCAPS) functions of the network management provided by the SMO 101.

Currently, secure, synchronous, low energy consumption O-RAN deployments are being considered. In some cases, the manner in which energy saving modes are trained and deployed may only be trained and predicted for a particular energy saving mode. In this way, an appropriate energy saving mode or corresponding energy saving configuration may not be obtained, resulting in low energy utilization of a network device (e.g., base station).

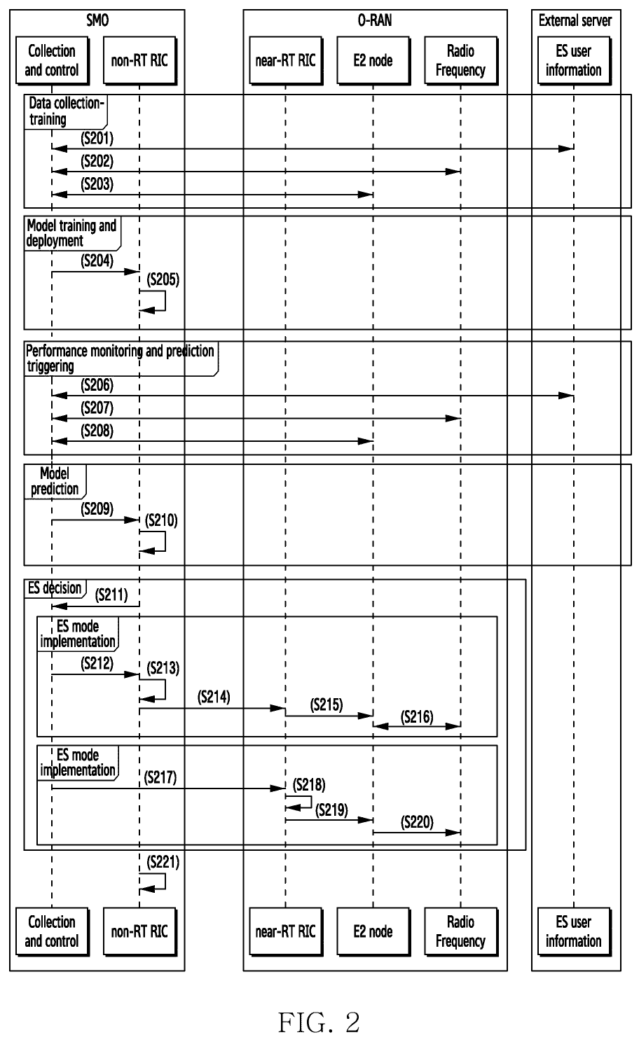

To address at least the above problems, some aspects of the disclosure provide an improved energy saving mode determination method. For example, a centralized management mode of some aspects of the disclosure may comprehensively analyze real-time energy savings metrics of the communication system to determine the optimal/best energy saving mode(s) that the system should use at this time. Compared to training and prediction for only one specific energy saving mode, some embodiments of the disclosure can take full advantage of large-scale data learning of AI/ML models for full energy saving mode training and prediction, thereby achieving a performance improvement for more optimal energy saving mode selection. An example implementation for determining an energy saving mode is described below in connection with FIG. 1E and FIG. 2.

FIG. 1E illustrates a flow diagram of selection of an energy saving mode and determination of a corresponding configuration in an O-RAN energy saving scheme (Near-RT RIC deployment), according to an embodiment of the disclosure. The method described in connection with FIG. 1E is merely an example, and some steps may be omitted or some new steps may be added.

Referring to FIG. 1E, through operations S101 to S103, a SMO entity may collect information related to energy saving (e.g., network energy saving) (which may also be referred to as energy saving related information or energy saving related data in the disclosure).

Operation S101 includes collection of external data (e.g., for model training). The SMO entity may collect information regarding a user scenario (which may also be referred to as user scenario related information, or user (e.g., terminal) related information in the disclosure) from an application server (e.g., edge server). For example, the user scenario related information may include one or more of a movement speed of a user, a movement direction of the user, user location information, and/or the like.

Operation S102 includes collection of measurement data (e.g., for model training). In operation S102, the SMO entity may collect information regarding an O-RU from an E2 node via an O1 interface or from a RF node (e.g., O-RU) via an O-FH interface. For example, the information regarding the O-RU may include one or more of information regarding power consumption of respective hardware components of the O-RU, information regarding an O-RU transmit power, and/or the like. The O-RU may measure the power consumption of the hardware components and report the measured power consumption to the SMO entity. The O-RU may determine the O-RU transmit power and report the O-RU transmit power to the SMO entity. In an embodiment of the disclosure, the E2 node may include an O-DU and/or an O-CU.

Operation S103 includes collection of measurement data (e.g., for model training). In operation S103, the SMO entity may collect information regarding the E2 node from the E2 node via the O1 interface. For example, the information regarding the E2 node may include one or more of: information regarding a cell uplink (UL) and/or downlink (DL) data flow, SSB signal measurement information (e.g., strength information, such as Reference Signal Received Quality (RSRQ), Reference Signal Received Power (RSRP), Signal to Interference Noise Ratio (SINR), etc.), a number of users in connected state, etc. The E2 node may determine (e.g., receive from terminals it serves) and report the energy saving related information to the SMO entity.

Operation S104 includes transmission of the collected data (e.g., for AI/ML model training). In operation S104, the SMO entity may transmit the collected data information to a Non-RT RIC.

Operations S105-S106 include AI/ML model training, deployment, and activation. In operation S105, an AI/ML model is trained by the Non-RT RIC based on the collected energy saving related data (e.g., by taking the collected energy saving related data as training data). The AI/ML model is trained to determine (e.g., predict or infer) an energy saving mode and/or user traffic load information based on the energy saving related data as input data. The trained AI/ML model may then be deployed at a Near-RT RIC in operation S106. For example, the Non-RT RIC may send the trained AI/ML model (e.g., parameters of the AI/ML model) to the Near-RT RIC to deploy the trained AI/ML model at the Near-RT RIC. The trained AI/ML model deployed at the Near-RT RIC may be activated to make predictions or inferences. The energy saving mode that is an output of the AI/ML model may include, for example, carrier/cell switch off, RF channel off, ASM, and/or the like. The user traffic load information as an output of the AI/ML model can assist the E2 node in selecting an energy saving mode to apply. For example, the E2 node may preferentially select an energy saving mode based on the output of the AI/ML model received from the Non-RT RIC.

Operations S107-S109 include energy saving performance monitoring and triggering of AI/ML model prediction. The energy saving performance monitoring may be the same as operations S101 to S103 except for the time at which the data is collected. Rather than operations S101 to S103 collecting long durations of data (e.g., measurement data over several days, such as 24 days), operations 107 to S109 periodically monitor real-time energy saving performance data (e.g., every few minutes, such as 5 minutes). The details regarding the energy saving performance data may refer to the description of the energy saving related data in operations S101 to S103. In operations S107 to S109, the SMO may confirm whether to trigger the prediction function of the AI/ML model according to the monitoring data. For example, whether or not the AI/ML model can be triggered to perform prediction of an energy saving mode and/or user traffic load information may be judged based on the real-time cell traffic load and inter-user interference information or the like.

Operations S110-S111 include transmission of collected data, e.g., for AI/ML model inference. In operation S110, the SMO entity may transmit the collected data information to the Near-RT RIC for AI/ML model prediction. The collected data information may, for example, include a mobility prediction, a traffic load prediction, user location information, O-RU related information, and/or the like.

Operation S112 includes prediction by the AI/ML model. In operation S112, based on the user scenario related information from the application server in real time and the energy saving related information from the E2 node (e.g., O-DU and/or O-CU) and/or the RF node (e.g., O-RU), the deployed AI/ML model may predict an energy saving mode and user traffic load information.

In operation S113, based on the information predicted by the AI/ML model, the SMO may determine an energy saving mode. For example, the Near-RT RIC may ask or request the SMO to recommend an energy saving mode; in response to the request of the Near-RT RI, the SMO may recommend an energy saving mode. The recommended energy saving mode may include, for example, carrier/cell switch off, RF channel off, ASM, and/or the like.

Operation S114 includes data transmission. In operation S114, the SMO may transmit the selected energy saving mode and the predicted user traffic load information to the Non-RT RIC for application of the energy saving mode.

Operation S115 includes determining (e.g., inferring) an energy saving configuration according to the energy saving mode. In operation S115, the Non-RT RIC may determine an energy saving configuration corresponding to the energy saving mode based on the energy saving mode. For example, an AI/ML model that has been deployed at the Non-RT RIC to infer an energy saving configuration (e.g., the AI/ML model may be another AI/ML model that is different from the AI/ML model described above), based on the energy saving mode determined by the SMO, infers a corresponding energy saving configuration. For example, if the SMO determines that energy saving mode is carrier/cell switch off, the AI/ML model deployed at the Non-RT RIC to infer energy saving configuration infers the corresponding configuration for carrier/cell switch off.

Operation S116 includes transmission of the recommended energy saving configuration and the predicted user traffic load information. In operation S116, the recommended energy saving configuration and the predicted user traffic load information are transmitted from the Non-RT RIC to the Near-RT RIC via an A1 interface, and then transmitted from the Near-RT RIC to the E2 node via the E2 interface.

In operation S117, the E2 node may determine an optimal energy saving configuration. The energy saving configuration derived by the E2 node from the predicted user traffic load information (the E2 node algorithm) may be compared with the recommended energy saving configuration (predicted by the AL/ML model) to finally select the optimal energy saving configuration.

Operation S118 includes updating and feedback of the optimal energy saving configuration. In operation S118, the E2 node may send the optimal energy saving configuration and receive a feedback on the update via the O-FH interface.

Operations S119-S122 include implementation of the optimal energy saving configuration. The details of operations S119 to S122 may refer to operations S114 to S118. In operations S119 to S122, the recommended energy saving configuration may be predicted by the AI/ML model deployed at the Near-RT RIC.

Operations S123-S124 include energy saving performance monitoring. In operation S123, the Non-RT RIC may continuously analyze the AI/ML model for energy saving mode prediction. If the energy saving performance target is not achieved or the system is in an unstable state (e.g., a high retransmission rate occurs), energy saving fallback or retraining and updating of the AI/ML model may be triggered. In operation S124, a trigger indication may be sent to the Near-RT RIC via the A1 interface.

An example of the input data of the AI/ML model is shown in Table 1. An example of the output data of the AI/ML model is shown in Table 2. The information elements listed in Tables 1 and 2 are merely examples. The input data for the AI/ML model may include one or more of the information elements shown in Table 1, or may include other information elements. The output data of the AI/ML model may include one or more of the information elements shown in Table 2, or may include other information elements.

TABLE 1
Example of input data for AI/ML model

| Information Element/ | | |
|---|---|---|
| Group Name | Presence | Semantic Description |
| > Bit Error Rate, | Yes | Bit error rate |
| Retransmission Rate | | |
| >>Total number of uplink | Yes | Total number of uplink |
| and/or downlink transport | | and/or downlink TBs of |
| blocks (TBs) of initial | | initial transmission |
| transmission | | |
| >>Number of uplink and/ | Yes | Number of uplink and/or |
| or downlink erroneous | | downlink erroneous TBs of |
| TBs of initial | | initial transmission |
| transmission | | (failed TBs of initial |
| | | transmission) |
| >>Total number of uplink | Yes | Total number of uplink |
| and/or downlink failed | | and/or downlink TBs |
| TBs | | (including total number |
| | | of all successful and |
| | | failed TBs of initial |
| | | transmission and |
| | | retransmission) |
| >>Total number of uplink | Yes | Total number of uplink |
| and/or downlink erroneous | | and/or downlink erroneous |
| TBs | | TBs (including total |
| | | number of all failed TBs |
| | | of initial transmission |
| | | and retransmission) |
| >>Number of uplink and/or | Yes | Number of uplink and/or |
| downlink residual | | downlink residual |
| erroneous TBs | | erroneous TBs |
| | | (including number of |
| | | erroneous/failed TBs |
| | | in last retransmission) |
| Uplink and/or downlink | Yes | Uplink and/or downlink |
| data volume between | | data volume from O-CU-UP |
| O-CU-UP and O-DU | | to O-DU per PLMN, per |
| | | QoS level, per slice, |
| | | per interface (F1-U, |
| | | Xn-U, X2-U) |
| SSB Measurement Data | Yes | RSRP/RSRQ/SINR |
| | | measurement per SSB |
| | | per cell |
| O-RU Energy Consumption | Yes | energy consumption of |
| | | O-RU, kWh |
| Hardware Energy | Yes | Energy consumption of |
| Consumption | | hardware components, W |
| Transmit Power | Yes | Transmit power, mW |
| Over the Air O-RU Energy | Yes | Over the air energy |
| Efficiency | | efficiency of O-RU as |
| | | calculated in O-DU |
| Number of users in | Yes | Number of RRC_{—} |
| connected state in | | CONNECTED users per |
| NG-RAN | | cell |
| >Multiple Input Multiple | Yes | MIMO related measurement |
| Output (MIMO) for Single | | |
| User (SU)/Multi-User | | |
| (MU) (SU/MU MIMO) | | |
| related measurement | | |
| >>SU/MU MIMO average | Yes | Mean measurement |
| number of uplink and/or | | |
| downlink transmission | | |
| layers and number of | | |
| physical resource blocks | | |
| (PRBs) | | |
| >>SU/MU MIMO average | Yes | Average utilization |
| uplink and/or downlink | | measurement |
| PRB utilization | | |
| >>SU/MU MIMO average | Yes | Average throughput |
| uplink and/or downlink | | measurement |
| throughput | | |
| >>Number of Sounding | Yes | Antenna switching |
| Reference Signal (SRS)- | | capability: whether |
| TxPortSwitches | | configured for antenna |
| supported by user | | switching and the type |
| | | of switching supported |
| | | SRS-TxPortSwitch = |
| | | tlrl, tlr2, tlr4 |
| >> Number of corresponding | Yes | Codebook capability |
| type (e.g., Type1/Type2) | | supported by user |
| codebooks supported by | | |
| user | | |
| >>Number of oneFL-DMRS- | Yes | Capability related to |
| TwoAdditionalDMRS-DL | | DMRS supported by user |
| supported by user | | |
| Uplink Reference Signal | Yes | Configuration information |
| Information | | of SRS and CSI-RS |
| UE External Information | Optional | Movement speed, movement |
| | | direction, orientation, |
| | | acceleration, and/or the |
| | | like of the user, which |
| | | are obtained through GPS. |

TABLE 2
Example of output data of AI/ML model

| Information Element/ | | |
|---|---|---|
| Group Name | Presence | Semantic Description |
| Energy saving mode | Yes | Carrier/cell switch off/on mode, |
| | | or RF channel reconfiguration |
| | | mode, or ASM |
| User traffic load prediction | Yes | Information of the size of the |
| information (cache | | user traffic load, which is used |
| information) | | for O-DU energy saving |
| | | algorithm |
| Confirmation message | Yes | Confirmation message |
| (success/failure) | | (success/failure) event |
| | | triggered |

FIG. 2 illustrates a flow diagram of selection of an energy saving mode and determination of a corresponding configuration in an O-RAN energy saving scheme (Non-RT RIC deployment), according to an embodiment of the disclosure. The method described in connection with FIG. 2 is only an example, and some steps may be omitted or some new steps may be added.

Referring to FIG. 2, through operations S201 to S203, a SMO entity may collect information (which may also be referred to as energy saving related information or energy saving related data in the disclosure) related to energy saving (e.g., network energy saving).

Operation S201 includes collection of external data (e.g., for model training). In operation S201, the SMO entity may collect user scenario related information from an application server, e.g. an edge server. For example, the user scenario related information may include one or more of a movement speed of a user, a movement direction of the user, user location information, and/or the like.

Operation S202 includes collection of measurement data (e.g., for model training). In operation S202, the SMO entity may collect information regarding an O-RU from an E2 node via an O1 interface or from an O-RU via an O-FH interface. For example, the information regarding the O-RU may include one or more of information regarding power consumption of respective hardware components of the O-RU, information regarding an O-RU transmit power, and/or the like. The O-RU may measure the power consumption of the hardware components and report the measured power consumption to the SMO entity. The O-RU may determine the O-RU transmit power and report the O-RU transmit power to the SMO entity. In an embodiment of the disclosure, the E2 node may include an O-DU and/or an O-CU.

Operation S203 includes collection of measurement data (e.g., for model training). In operation S203, the SMO entity may collect information regarding the E2 node from the E2 node via the O1 interface. For example, the information regarding the E2 node may include one or more of information regarding a cell UL and/or DL data flow, SSB signal measurement information (e.g., strength information, such as RSRQ, RSRP, SINR, etc.), a number of users in connected state, and/or the like. The E2 node may determine (e.g., receive from terminals it serves) and report the energy saving related information to the SMO entity.

Operation S204 includes data transmission (e.g., for model training). In operation S204, the SMO entity may transmit the collected data information to a Non-RT RIC.

Operation S205 includes AI/ML model training, deployment, and activation. In operation S205, the AI/ML model is trained by the Non-RT RIC based on the collected energy saving related data (e.g., by taking the collected energy saving related data as training data). The AI/ML model is trained to determine (e.g., predict or infer) an energy saving mode and/or user traffic load information based on the energy saving related data as input data. The trained AI/ML model may be deployed and/or activated (e.g., to trigger model prediction) at the Non-RT RIC. The trained AI/ML model deployed at the Non-RT RIC may be activated to make predictions or inferences. The energy saving mode that is an output of the AI/ML model may include, for example, one or more of carrier/cell switch off, RF channel off, ASM, and/or the like. The user traffic load information as an output of the AI/ML model can assist the E2 node in selecting an energy saving mode to apply. The E2 node can preferentially select an energy saving mode based on the user traffic load information received from the Non-RT RIC.

Operations S206-S208 include energy saving performance monitoring and triggering of model prediction. The energy saving performance monitoring may be the same as operations S201 to S203 except for the time at which the data is collected. Rather than operations S201-S203 collecting long durations of data (e.g., measurement data over several days, such as 24 days), operations S206 to S208 periodically monitor real-time energy saving performance data (e.g., every few minutes, such as 5 minutes). The details regarding the energy saving performance data may refer to the description of the energy saving related data in operations S201 to S203. In operations S206 to S208, the SMO may confirm whether to trigger the prediction function of the AI/ML model according to the monitoring data. The prediction of an energy saving mode and/or user traffic load information by the AI/ML model may be triggered, for example, based on the real-time cell traffic load and inter-user interference information, and/or the like.

Operation S209 includes transmission of the data for AI/ML model inference (e.g., prediction). In operation S209, the SMO entity may transmit the collected data information for model prediction to the Non-RT RIC for prediction by the AI/ML model at the Non-RT RIC. For example, the collected data information may include one or more of movement speed of a user, a movement direction of the user, user location information, O-RU measurement information, and/or the like.

Operation S210 includes prediction by the AI/ML model. In operation S210, based on the user scenario related information from the application server in real time and the energy saving related information from the E2 node and the O-RU, the deployed AI/ML model predicts an energy saving mode and user traffic load information.

Operation S211 includes, based on the information predicted by the AI/ML model, the Non-RT RIC asking the SMO to make a recommendation for energy saving mode. For example, the recommended energy saving mode may include one or more of carrier/cell switch off, RF channel off, ASM, and/or the like.

Operation S212 includes data transmission. In operation S212, the SMO may transmit the selected energy saving mode and the predicted user traffic load information to the Non-RT RIC for application of the energy saving mode.

Operation S213 includes determining (e.g., using AI/ML model to inference) an energy saving configuration according to the energy saving mode. In operation S213, the Non-RT RIC may determine an energy saving configuration corresponding to the energy saving mode based on the energy saving mode. For example, an AI/ML model that has been deployed at the Non-RT RIC to infer an energy saving configuration (e.g., the AI/ML model may be another AI/ML model that is different from the AI/ML model described above), based on the energy saving mode confirmed by the SMO, infers a corresponding energy saving configuration. For example, in case that SMO determines the energy saving mode as carrier/cell switch off, the AI/ML model deployed at the Non-RT RIC for carrier/cell switch off configuration infers the corresponding configuration of carrier/cell switch off.

Operation S214 includes transmission of the recommended energy saving configuration and predicted user traffic load information. In operation S214, the recommended energy saving configuration and the predicted user traffic load information are transmitted from the Non-RT RIC to a Near-RT RIC via an A1 interface, and then transmitted from the Near-RT RIC to the E2 node via the E2 interface.

Operation S215 includes the E2 node determining an optimal energy saving configuration. The energy saving configuration derived by the E2 node based on the predicted user traffic load information (the E2 node algorithm) is compared with the recommended energy saving configuration (predicted by the AL/ML model) and finally the optimal energy saving configuration is selected.

Operation S216 includes updating and feedback of the optimal energy saving configuration. In operation S216, the E2 node may send the optimal energy saving configuration via the O-FH interface and receive a feedback on the update.

Operations S217 to S220 include implementation of the optimal energy saving configuration. Like operations S212 to S216, in operations S217 to S220, the recommended energy saving configuration may be predicted by an AI/ML model (AI/ML model for energy saving mode prediction) deployed at the Near-RT RIC.

Operation S221 includes energy saving performance monitoring. In operation S221, the Non-RT RIC may continuously analyze the AI/ML model for energy saving mode prediction, and may trigger energy saving fallback or updating and retraining of the AI/ML model if the energy saving performance target is not achieved or the system is in an unstable state (e.g., a high retransmission rate occurs).

The input data and output data of the AI/ML model of the Non-RT RIC deployment scheme described in connection with FIG. 2 may be the same as the input data and output data of the AI/ML model of the Near-RT RIC deployment described in connection with FIG. 1D. An example of the input data of the AI/ML model is shown in Table 1. An example of the output data of the AI/ML model is shown in Table 2. The information elements listed in Tables 1 and 2 are merely examples. The input data for the AI/ML model may include one or more of the information elements shown in Table 1, or may include other information elements. The output data of the AI/ML model may include one or more of the information elements shown in Table 2, or may include other information elements.

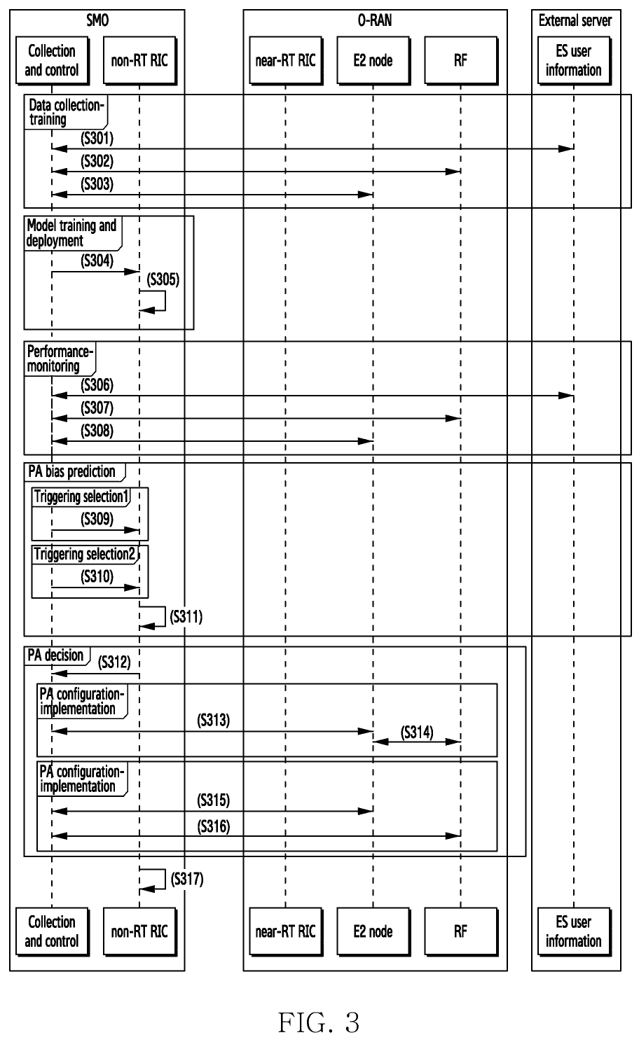

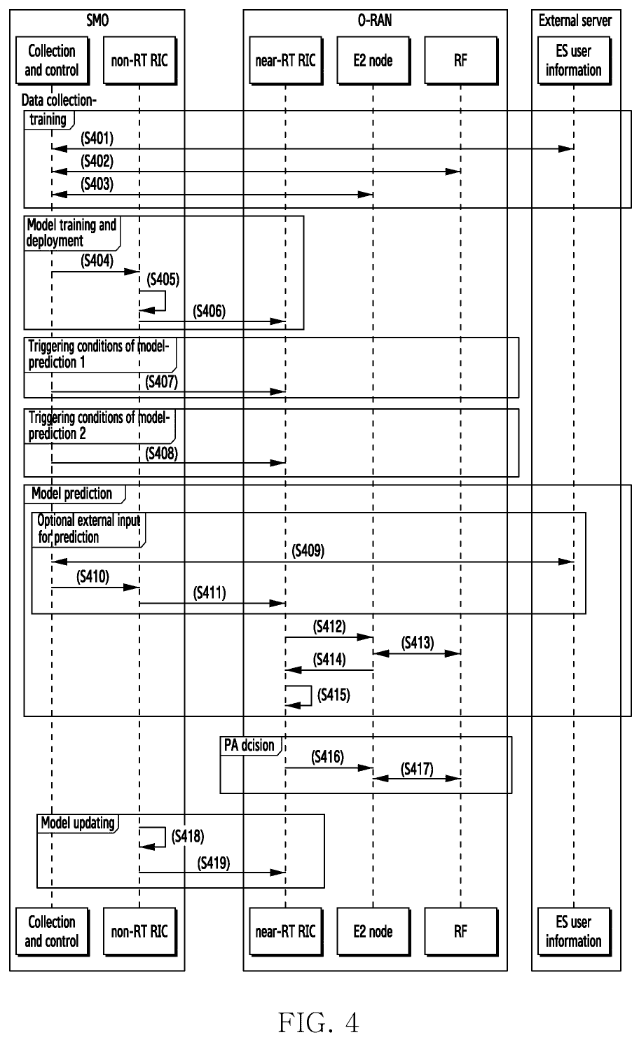

In some cases, a power amplifier (PA) bias/bias value of a network node or entity (e.g., E2 node) may be controlled based on multi-voltage level (voltage level may be, but is not limited to, voltage value or voltage value index, e.g., voltage level 1=30 Volts (v) or voltage level 1=index 1; voltage level 2=25 v or voltage level 2=index 2; voltage level 3=20 v or voltage level 3=index 3; voltage level 4=15 v or voltage level 4=index 4; voltage level 5=10 v or voltage level 5=index 5), which obtains fine granularity in voltage level control, thereby achieving better energy savings. In addition, the use of the intelligent controller in the O-RAN architecture allows for a finer granularity of temporal control of the voltage bias, i.e., faster and more sensitive voltage control, resulting in better energy savings. The energy saving mode of PA bias control may make up for the absence of the energy saving mode for ORAN frequency domain, further balancing user experience and energy saving efficiency. Methods of providing finer granularity PA bias control according to some embodiments of the disclosure are described below in connection with FIGS. 3 and 4, respectively.

FIG. 3 illustrates a flow diagram of PA bias control and determination of a corresponding configuration in an O-RAN energy saving scheme (Non-RT RIC deployment), according to an embodiment of the disclosure.

Referring to FIG. 3, through operations S301 to S303, a SMO entity may collect information (which may also be referred to as energy saving related information or energy saving related data in the disclosure) related to energy saving (e.g., network energy saving).

Operation S301 includes collection of external data (e.g., for model training). In operation S301, the SMO entity may collect user scenario related information from an application server, e.g. an edge server. For example, the user scenario related information may include one or more of a movement speed of a user, a movement direction of the user, user location information, and/or the like.

Operation S302 includes collection of measurement data (e.g., for model training). In operation S302, the SMO entity may collect information regarding an O-RU from an E2 node via an O1 interface or from a RF node (e.g., O-RU) via an O-FH interface. For example, the information regarding the O-RU may include one or more of information regarding power consumption of respective hardware components of the O-RU, information regarding an O-RU transmit power, and/or the like. The O-RU may measure the power consumption of the hardware components and report the measured power consumption to the SMO entity. The O-RU may determine the O-RU transmit power and report the O-RU transmit power to the SMO entity. In an embodiment of the disclosure, the E2 node may include an O-DU and/or an O-CU.

Operation S303 includes collection of measurement data (e.g., for model training). In operation S303, the SMO entity may collect information regarding the E2 node from the E2 node via the O1 interface. For example, the information regarding the E2 node may include one or more of: information regarding a cell UL/DL data flow, SSB signal measurement information (e.g., strength information, such as RSRQ, RSRP, SINR, etc.), a number of users in connected state, and/or the like. The E2 node may determine (e.g., receive from terminals it serves) and report the energy saving related information to the SMO entity.

Operation S304 includes transmission of collected data, e.g., for AI/ML model training. In operation S304, the SMO entity may transmit the collected data information to a Non-RT RIC.

Operation S305 includes AI/ML model training, deployment, and activation. In operation S305, an AI/ML model is trained by the Non-RT RIC based on the collected energy saving related data (e.g., by taking the collected energy saving related data as training data). The AI/ML model is trained to determine (e.g., predict or infer) PA bias/bias value based on the energy saving related data as input data. The trained AI/ML model is then deployed and/or activated at the Non-RT RIC. For example, the determined PA bias may include Voltage Level 1=30 v or Voltage Level 1=Index 1, Voltage Level 2=25 v or Voltage Level 2=Index 2, etc.

Operations S306-S308 include energy saving performance and system performance monitoring and triggering of PA bias prediction by the AI/ML model. Energy saving performance and system performance monitoring may be associated with operations S301-S303, except for the time at which data is collected. Instead of operations S301-S303 collecting a long duration of data (e.g., several days (such as 24 days) of measurement data), operations S306-S308 periodically monitor real-time energy saving performance and system performance data (e.g., every few minutes (such as 5 minutes)). For details about the energy saving performance data, reference may be made to the description of the energy saving related data in operations S301 to S303. In operation S306 through operation S308, the SMO may determine whether to trigger the function of the AI/ML model to predict the PA bias based on the monitored data. For example, whether or not the AI/ML model can be triggered to make a prediction of PA bias control may be determined based on real-time user traffic and system error rate information, and/or the like.

Operation S309 includes triggering inference of the AI/ML model with transmission of the required data (Option 1). In operation S309, the SMO entity may determine whether to trigger inference of the AI/ML model based on the PA bias related measurements collected in operations S306-S308, and transmit the collected data information for prediction by the AI/ML model to the Non-RT RIC. For example, the collected data information may include a movement speed of a user, a movement direction of the user, system error rate information, and/or the like.

Operation S310 includes triggering inference of the AI/ML model and transmission of the required data (Option 2). In operation S310, the SMO entity may trigger inference of the AI/ML model for PA bias prediction based on the determination of an energy saving mode selection module, and transmit the collected data information for model prediction to the Non-RT RIC. For example, the collected data information may include a movement speed of a user, a movement direction of the user, system error rate information, and/or the like.

Operation S311 includes prediction by the AI/ML model. In operation S311, the deployed AI/ML model predicts an optimal PA bias/bias value based on the user scenario related information from the application server in real time and the energy saving related information from the E2 node and the O-RU.

In operation S312, based on the information predicted by the AI/ML model, the SMO may determine E2 node resource configuration information corresponding to the PA bias. For example, the Non-RT RIC may ask or request the SMO to determine the E2 node resource configuration information corresponding to the PA bias; in response to the request from the Non-RT RIC, the SMO may determine E2 node resource configuration information corresponding to the PA bias. For example, the E2 node resource configuration information may include a time-frequency resource configuration of a downlink channel (e.g., a physical downlink shared channel (PDSCH)), or the like.

Operation S313 includes transmission of the E2 node configuration information. The SMO transmits the PA bias value configuration and E2 node configuration information to the E2 node via the O1 interface for application of PA bias value control.

Operation S314 includes updating and feedback of the optimal PA bias configuration. In operation S314, the E2 node may send the optimal PA bias configuration via the O-FH CUS-plane or M-plane interface and receive a feedback on the update.

Operation S315 includes transmission of the E2 node configuration information (optional). Operation S315 may be the same as operation S313.

Operation S316 includes an update and feedback of the optimal PA bias configuration (optional). In operation S316, the SMO may send the optimal PA bias configuration and receive a feedback on the update via the O-FH M-plane interface.

The data model (e.g., YANG model) corresponding to the PA bias send by the SMO or E2 via the O-FH CUS-plane or M-plane interface in operations 314 and 316 above may be, but is not limited to, the following from:

```
--o-ran-hardware
  .
  .
  .
  -- pa-bias-control : enumeration {
normal ( 0 )
Level1 ( 1 )
Level2 ( 2 )
.
.
.
}
```

Operation S317 includes system performance monitoring. In operation S317, the Non-RT RIC may continuously analyze the AI/ML model for PA bias prediction. If the energy saving performance target is not achieved or the system is in an unstable state (e.g., the bit error rate of the system is high), energy saving fallback or retraining and updating of the AI/ML model may be triggered.

An example of the input data for the AI/ML model at the Non-RT RIC described in connection with FIG. 3 is shown in Table 3. An example of the output data of the AI/ML model is shown in Table 4. The information elements listed in Tables 3 and 4 are merely examples. The input data for the AI/ML model may include one or more of the information elements shown in Table 3, or may include other information elements. The output data of the AI/ML model may include one or more of the information elements shown in Table 4, or may include other information elements.

TABLE 3
Example of input data for AI/ML Model

| Information Element/ | | |
|---|---|---|
| Group Name | Presence | Semantic Description |
| > Bit Error Rate, | Yes | Bit Error Rate |
| Retransmission Rate | | |
| >>Total number of uplink | Yes | Total number of initial TBs |
| and/or TBs of initial | | up and down |
| transmission | | |
| >>Number of uplink and/or | Yes | Number of uplink and/or |
| downlink erroneous TBs of | | downlink erroneous TBs of |
| initial transmission | | initial transmission |
| >>Total number of uplink | Yes | Total number of uplink and/ |
| and/or downlink TBs | | or downlink TBs |
| >>Total number of uplink | Yes | Total number of uplink and/ |
| and/or downlink failed TBs | | or downlink failed TB |
| >>Number of uplink and/or | Yes | Number of uplink and/or |
| downlink residual | | downlink residual erroneous |
| erroneous TBs | | TBs |
| Uplink and/or downlink | Yes | Uplink and/or downlink data |
| data volume between | | volume from O-CU-UP to |
| O-CU-UP and O-DU | | O-DU per PLMN, per QoS |
| | | level, per slice, per |
| | | interface (F1-U, Xn-U, |
| | | X2-U) |
| O-RU Energy Consumption | Yes | Energy consumption of |
| | | O-RU, kWh |
| Hardware Energy | Yes | Energy consumption of |
| Consumption | | hardware components, W |
| Transmit Power | Yes | Transmit power, mW |
| Over the Air O-RU | Yes | Over the air energy efficiency |
| Energy Efficiency | | of O-RU as calculated in O-DU |
| O-RU PA Bias Level | Yes | Information regarding PA bias |
| | | level of O-RU |
| UE External | Optional | Movement speed, movement |
| Information | | direction, orientation, |
| | | acceleration, and/or the like |
| | | of the user, which are |
| | | obtained through GPS. |

TABLE 4
Example of output data of AI/ML model

| Information Element/ | | |
|---|---|---|
| Group Name | Presence | Semantic Description |
| PA Control Voltage | Yes | PA control voltage level may be, |
| Level | | but is not limited to, = 30 v or |
| | | voltage level = index value 1 |
| PDSCH Resource | Yes | PDSCH resource configuration |
| Reconfiguration | | |
| Maximum RB number of | Yes | Maximum number of RBs that |
| E2 node | | can be scheduled by E2 node |
| Confirmation message | Yes | Confirmation Message |
| (success/failure) | | (success/failure) event triggered |

FIG. 4 illustrates a flow diagram of PA bias control and determination of a corresponding configuration in an O-RAN energy saving scheme (Near-RT RIC deployment), according to an embodiment of the disclosure.

Referring to FIG. 4, through operations S401 to S403, a SMO entity may collect information (which may also be referred to as energy saving related information or energy saving related data in the disclosure) related to energy saving (e.g., network energy saving).

Operation S401 includes collection of external data (e.g., for model training). In operation S401, the SMO entity may collect user scenario related information from an application server (e.g. an edge server). For example, the user scenario related information may include one or more of a movement speed of a user, a movement direction of the user, user location information, and/or the like.

Operation S402 includes collection of measurement data (e.g., for model training). For example, the SMO entity may collect information regarding the O-RU from an E2 node via an O1 interface or from an O-RU via an O-FH interface. The information regarding the O-RU may include one or more of information regarding power consumption of respective hardware components of the O-RU, information regarding an O-RU transmit power and/or information regarding RF PA bias levels supported by the O-RU, and/or the like. The O-RU may measure the power consumption of the hardware components and report the measured power consumption to the SMO entity. The O-RU may determine the O-RU transmit power and report the O-RU transmit power to the SMO entity. In an embodiment of the disclosure, the E2 node may include an O-DU and/or an O-CU.

Operation S403 includes collection of measurement data (e.g., for model training). For example, the SMO entity may collect information regarding the E2 node from the E2 node via the O1 interface. For example, the information regarding the E2 node may include one or more of information regarding a cell UL and/or DL data flow, SSB signal measurement information (e.g., strength information, such as RSRQ, RSRP, SINR, etc.), a number of users in connected state, and/or the like.

Operation S404 includes data transmission (e.g., for model training). In operation S404, the SMO entity may transmit the collected data information to a Non-RT RIC.

Operation S405 includes AI/ML model training. In operation S405, an AI/ML model is trained by the Non-RT RIC based on the collected energy saving related data (e.g., by taking the collected energy saving related data as training data). The AI/ML model is trained to determine (e.g., predict or infer) a PA bias value based on the energy saving related data as input data. For example, the PA bias value may include Voltage Level 1=30 v or Voltage Level 1=Index 1, Voltage Level 2=25 v or Voltage Level 2=Index 2, and/or the like.

Operation S406 includes deployment of the AI/ML model. In operation S406, the Non-RT RIC may deploy the trained AI/ML model to a Near-RT RIC via the O1/O2 interface. For example, the Non-RT RIC may send model parameters related to the trained AI/ML model to the Near-RT RIC via the O1/O2 interface.

Operation S407 includes transmission of a trigger condition for model prediction (Option 1). In operation S407, the SMO may transmit a model trigger conditions and a performance monitoring indicator to the Near-RT RIC via the O1 interface or the Non-RT RIC via an A1 interface for instructing the Near-RT RIC to monitor energy saving performance targets and trigger model prediction.

Operation S408 includes transmission of a trigger condition for model prediction (Option 2). In operation S408, the SMO may transmit the energy saving mode of the PA bias value predicted based on the energy saving mode to the Near-RT RIC via the O1 interface or the Non-RT RIC may transmit the energy saving mode of the PA bias value predicted based on the energy saving mode to the Near-RT RIC via the A1 interface for directing the Near-RT RIC to monitor energy saving performance targets and trigger model prediction.

Operations S409-S411 include data information collection for model prediction (optional). In operation S409, the SMO entity may collect user scenario related information from an application server (e.g., an edge server). For example, the user scenario related information may include one or more of a movement speed of a user, a movement direction of the user, user location information, and/or the like. Then, the collected user scenario-related information is transmitted to the Near-RT RIC through operation S410 and operation S411. If the prediction requires external information support, the cycle period of the prediction of the Near-RT RIC will be aligned with the cycle period of the Non-RT RIC.

Operation S412 includes data information collection for model prediction. In operation S412, the Near-RT RIC may request acquisition of energy saving related information from the E2 node via the E2 interface. The energy saving related information may include E2 node energy saving related information and O-RU energy saving measurement information. For example, the E2 node energy saving related information may include one or more of information regarding a cell UL and/or DL data flow, SSB signal measurement information (e.g., strength information, such as RSRQ, RSRP, SINR, etc.), a number of users in connected state, and/or the like. For example, the O-RU energy saving measurement information may include one or more of information regarding power consumption of respective hardware components of the O-RU, information regarding an O-RU transmit power, and/or the like.

Operation S413 includes O-RU energy saving related measurement and measurement information reporting. In operation S413, the O-RU may measure the energy saving related measurement quantity in real time and report to the E2 node. For example, the energy saving related measurement quantity may include one or more information regarding power consumption of respective hardware components of the O-RU, information regarding an O-RU transmit power, and/or the like.

Operation S414 includes energy saving related information reporting. In operation S414, the E2 node may report the collected energy saving measurement related information to the Near-RT RIC via the E2 interface.

Operation S415 includes AI/ML model inference. In operation S415, the deployed AI/ML model infers the optimal PA bias value and its E2 node configuration based on the real-time energy saving measurement information, e.g., PA bias value: Voltage Level 2=25 v or Voltage Level 2=Index2 and E2 node time-frequency resource configuration.

Operations S416 through 8417 include PA bias values and E2 node configuration. In operation S416 through operation S417, the Near-RT RIC may transmit the PA bias and the corresponding E2 node configuration to the E2 node via the E2 interface, and the E2 node may select the optimal PA bias and its E2 configuration based on the model-inferred configuration and local algorithms, and configure the O-RU via the O-FH interface, and receive the PA value update feedback for the O-RU via the O-FH.

The data model (e.g., YANG model) corresponding to the PA bias value sent via the O-FH CUS-plane or M-plane interface may be, but is not limited to, the following from:

```
--o-ran-hardware
  .
  .
  .
  -- pa-bias-control : enumeration {
normal ( 0 )
Level1 ( 1 )
Level2 ( 2 )
.
.
.
}
```

Operation S418 includes system performance monitoring. In operation S418, the Non-RT RIC may continuously analyze the AI/ML model for PA bias value prediction. If the energy saving performance target is not achieved or the system is in an unstable state (e.g., the bit error rate of the system is high), energy saving fallback or updating and retraining of the AI/ML model may be triggered.

Operation S419 includes updating the model deployment. In operation S419, the Non-RT RIC may deploy the updated AI/ML model to the Near-RT RIC via the A1 interface.

The input data and output data of the AI/ML model of the Near-RT RIC deployment scheme described in connection with FIG. 4 may be the same as the input data and output data, respectively, of the AI/ML model of the Non-RT RIC deployment scheme described in connection with FIG. 3. An example of the input data of the AI/ML model is shown in Table 3. An example of the output data of the AI/ML model is shown in Table 4. The information elements listed in Tables 3 and 4 are merely examples. The input data for the AI/ML model may include one or more of the information elements shown in Table 3, or may include other information elements. The output data of the AI/ML model may include one or more of the information elements shown in Table 4, or may include other information elements.

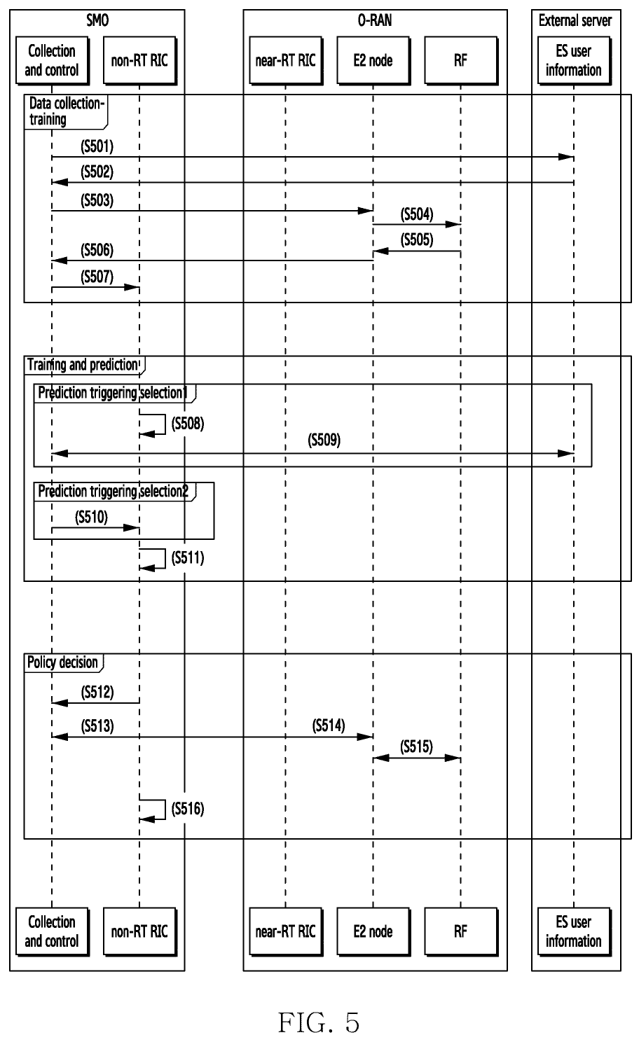

Flow optimization and performance parameter optimization based on existing examples of ORAN according to some embodiments of the disclosure will be described below with reference to FIGS. 5 through 10.

Mobile networks typically utilize multiple frequency layers (carriers) to cover the same service area. Some solutions may achieve energy savings by switching off one or more carriers or the entire cell only at low loads, i.e., when the expected traffic load is below a fixed threshold, so that the user experience is not compromised.

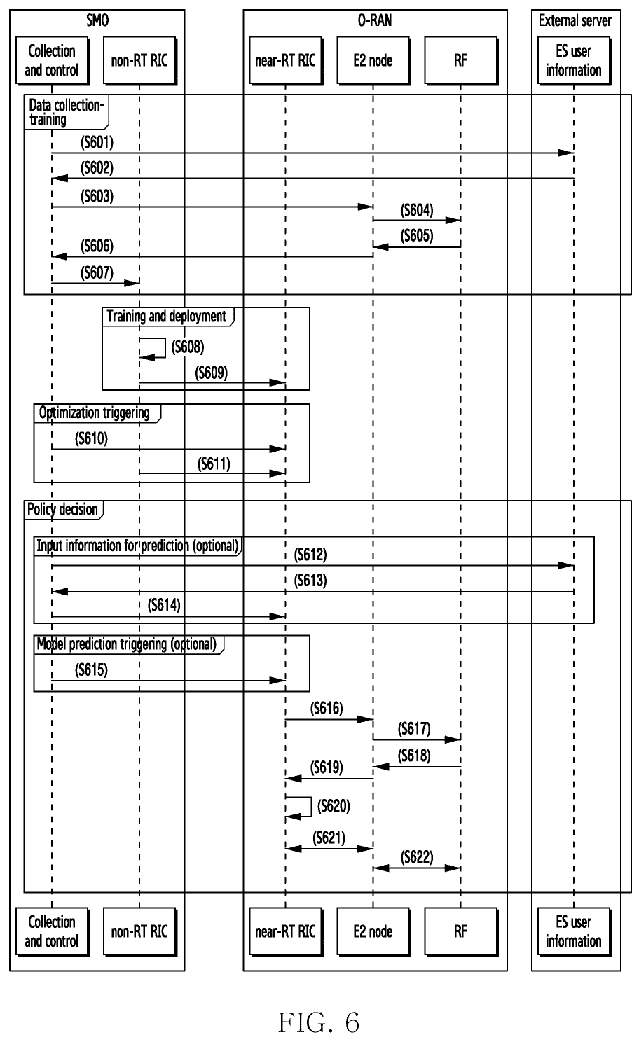

Unlike the above scheme, the method scheme according to some embodiments of the disclosure can improve the overall throughput of the system by switching off certain interfering carriers in consideration of inter-user intra-carrier interference under non-low load, i.e., when the expected traffic load is not lower than a fixed threshold, thereby improving the energy efficiency and achieving a better energy saving effect. An energy saving scheme of switching off a carrier or an entire cell under non-low load according to some embodiments of the disclosure is described below in connection with FIGS. 5 and 6.

FIG. 5 illustrates a flow diagram of a determination of a carrier/cell switch off/on energy saving method and corresponding configuration in an O-RAN energy saving scheme (Non-RT RIC deployment), according to an embodiment of the disclosure.

Referring to FIG. 5, through operations S501 to S503, a SMO entity may collect information (which may also be referred to as energy saving related information or energy saving related data in the disclosure) related to energy saving (e.g., network energy saving).

Operations S501-S502 include collection of external data (e.g., for model training). In operations S501 to S502, the SMO entity may collect user scenario related information from an application server (e.g., an edge server). For example, the user scenario related information may include one or more of a movement speed of a user, a movement direction of the user, user location information, and/or the like.

Operations S503-S504 include collection of measurement data (e.g., for model training). In operations S503 to S504, the SMO entity may collect energy saving related information from an E2 node and an O-RU via the E2 node and an O-FH interface. For example, the energy saving related information may include one or more of information regarding power consumption of respective carriers, information regarding load of respective cells and respective carriers, and/or the like.

Operations S505-S506 include measurement data transmission (e.g., for model training). In operations S505 to S506, the E2 node and the O-RU may transmit measurement data to the SMO via the O-FH and the E2 node periodically or event based. For example, the measurement data may include one or more of information regarding power consumption of respective carriers, information regarding load of respective cells and respective carriers, and/or the like.

Operation S507 includes data transmission for model training. In operation S507, a Non-RT RIC may retrieve the collected measurement data for processing.

Operations S508-S510 include prediction trigger 1: trigger model prediction by monitoring. In operations S508 to S510, the Non-RT RIC may continuously monitor the energy consumption of the E2 node and the O-RU and the performance of the E2 node, and the SMO may continuously collect external user scenario related information. For example, the user scenario related information may include one or more of a movement speed of a user, a movement direction of the user, user location information, and/or the like. The SMO may transmit the collected information to the Non-RT RIC. The prediction of AI/ML model in the Non-RT RIC may be triggered based on energy saving performance and monitoring information of external information.

Operation S511 includes prediction trigger 2: trigger prediction by selection of an energy saving mode. In operation S511, the Non-RT RIC may trigger prediction based on the energy saving mode of carrier/cell switch on/off selected by the SMO.

Operation S512 includes AI/ML model training and prediction. In operation S512, the Non-RT RIC may train an AI/ML model based on the collected data. The Non-RT RIC may activate the prediction of the AI/ML model based on trigger 1 or trigger 2.

Operation S513 includes preparing and performing cell/carrier on/off switching. In operation S513, according to the inference of the AI/ML model, the Non-RT RIC may request the SMO to prepare and perform cell/carrier on/off switching by configuring the E2 node and the O-RU.

Operations S514 to S515 include updating the E2 node and O-RU configuration. In operations S514 to S515, the SMO may indicate/instruct the E2 node, via the O1 interface, to perform an E2 node configuration update as well as a configuration update of carrier/cell switch off/on, and collect a feedback message of the configuration update. The O-RU receives the updated O-RU configuration and performs update feedback over the O-FH M-plane interface of the E2 node.

Operation S516 includes performance monitoring of the AI/ML model. In operation S516, the Non-RT RIC continuously analyzes the performance of the AI/ML model. If the energy saving target is not reached, it may decide to initiate a fallback mechanism and/or AI/ML model update or retraining.

An example of input data for the AI/ML model described in connection with FIG. 5 is shown in Table 1. An example of the output data of the AI/ML model is shown in Table 2. The information elements listed in Tables 5 and 6 are merely examples. The input data for the AI/ML model may include one or more of the information elements shown in Table 5, or may include other information elements. The output data of the AI/ML model may include one or more of the information elements shown in Table 6, or may include other information elements.

TABLE 5
Example of input data for AI/ML model

| Information Element/ | | |
|---|---|---|
| Group Name | Presence | Semantic Description |
| Uplink and/or downlink | Yes | Uplink and/or downlink data |
| data volume between | | volume from O-CU-UP to O-DU |
| O-CU-UP and O-DU | | per PLMN, per QoS level, |
| | | per slice, per interface |
| | | (F1-U, Xn-U, X2-U) |
| SSB Measurement | Yes | RSRP/RSRQ/SINR measurement |
| Data | | per SSB per cell |
| O-RU energy | Yes | Energy consumption of O-RU, |
| consumption | | kWh |
| Hardware Energy | Yes | Energy consumption of |
| Consumption | | hardware components, W |
| Transmit Power | Yes | Transmit power, mW |
| Inter-user interference | Yes | SRS-based measurement report |
| measurement information | | |

TABLE 6
Example of output data of AI/ML model

| Information Element/ | | |
|---|---|---|
| Group Name | Presence | Semantic Description |
| Recommend candidate | Yes | Recommend candidate carrier(s)/ |
| carrier/cell for energy | | cell(s) for energy saving to |
| saving to enter energy | | enter energy saving state |
| saving state | | |
| Candidate carriers/ | Optional | Candidate carrier(s)/cell(s) |
| cells for compensation | | for compensation |
| Confirmation Message | Yes | Confirmation message (success/ |
| (success/failure) | | Failure) event triggered |
| Updated Carrier | Yes | Updated carrier configuration |
| Configuration | | (e.g., activation, deactivation, |
| | | or sleep) |

FIG. 6 illustrates a flow diagram of a determination of a carrier/cell switch off/on energy saving method and corresponding configuration in an O-RAN energy saving scheme (Near-RT RIC deployment), according to an embodiment of the disclosure.

Referring to FIG. 6, through operations S601-603, a SMO entity may collect information (which may also be referred to as energy saving related information or energy saving related data in the disclosure) related to energy saving (e.g., network energy saving).

Operations S601-S602 include collection of external data (e.g., for model training). In operation S601-operation S602, the SMO entity may collect user scenario related information from an application server (e.g., an edge server). For example, the user scenario related information may include one or more of a movement speed of a user, a movement direction of the user, user location information, and/or the like.

Operations S603-S604 include collection of measurement data (e.g., for model training). In operations S603 to S604, the SMO entity may collect energy saving related information from an E2 node and an O-RU via the E2 node and an O-FH interface. For example, the energy saving related information may include one or more of information regarding power consumption of respective carriers, information regarding load of respective cells and respective carriers, and/or the like.

Operations S605-S606 include measurement data transmission (e.g., for model training). In operation S605-operation S606, the E2 node and the O-RU may send measurement data to the SMO via the O-FH and the E2 node periodically or event based. For example, the measurement data may include one or more of information regarding power consumption of respective carriers, information regarding load of respective cells and respective carriers, and/or the like.

Operation S607 includes data transmission (e.g., for model training). In operation S607, a Non-RT RIC may retrieve and process the collected measurement data.

Operations S608-S609 include AI/ML model training and deployment. Operation S608, the Non-RT RIC may train an AI/ML model based on the collected data. In operation S609, the Non-RT RIC may deploy the trained AI/ML model at the Near-RT RIC. For example, the Non-RT RIC may send model parameters related to the trained AI/ML model to a Near-RT RIC via an O1/O2 interface.

In operations S610 to S611, the SMO may trigger EE/ES optimization and may provide a strategy of knowing the Near-RT RIC energy saving function via the O1 interface and/or via the Non-RT RIC and A1 interface.

Operations S612-S614 include collection of external input information (e.g., for model prediction) (optional). In operation S613, the SMO may continuously collect external user scenario related information. For example, the user scenario related information may be provided by an external server in response to the request of the SMO in operation S612. For example, the user scenario related information may include one or more of a movement speed of a user, a movement direction of the user, user location information, and/or the like. The collect external user scenario related information may be transmitted to the Near-RT RIC.

Operation S615 includes triggering prediction (optional) by the selection of an energy saving mode. In operation S615, the Near-RT RIC may trigger prediction based on the energy saving mode of carrier/cell switch on/off selected by the SMO.

Operations S616-S619 include data collection (e.g., for model prediction). The Near-RT RIC continuously monitors (i) performance and energy consumption of the E2 node and/or (ii) energy consumption of the O-RU and collects relevant information as input information for AI/ML model prediction.

In operations S620 to S622, based on the AI/ML inference, the Near-RT RIC may request the E2 node to prepare and perform cell or carrier off/on switching considering the optimization strategy. The E2 node may request the O-RU node to prepare and perform cell or carrier off/on switching. The E2 node will notify the Near-RT RIC after cell or carrier off/on switching is complete.

The input data and output data of the AI/ML model of the Near-RT RIC deployment scheme described in connection with FIG. 6 may be the same as the input data and output data of the AI/ML model of the Non-RT RIC deployment described in connection with FIG. 5. An example of the input data of the AI/ML model is shown in Table 5. An example of the output data of the AI/ML model is shown in Table 6. The information elements listed in Tables 5 and 6 are merely examples. The input data for the AI/ML model may include one or more of the information elements shown in Table 5, or may include other information elements. The output data of the AI/ML model may include one or more of the information elements shown in Table 6, or may include other information elements.

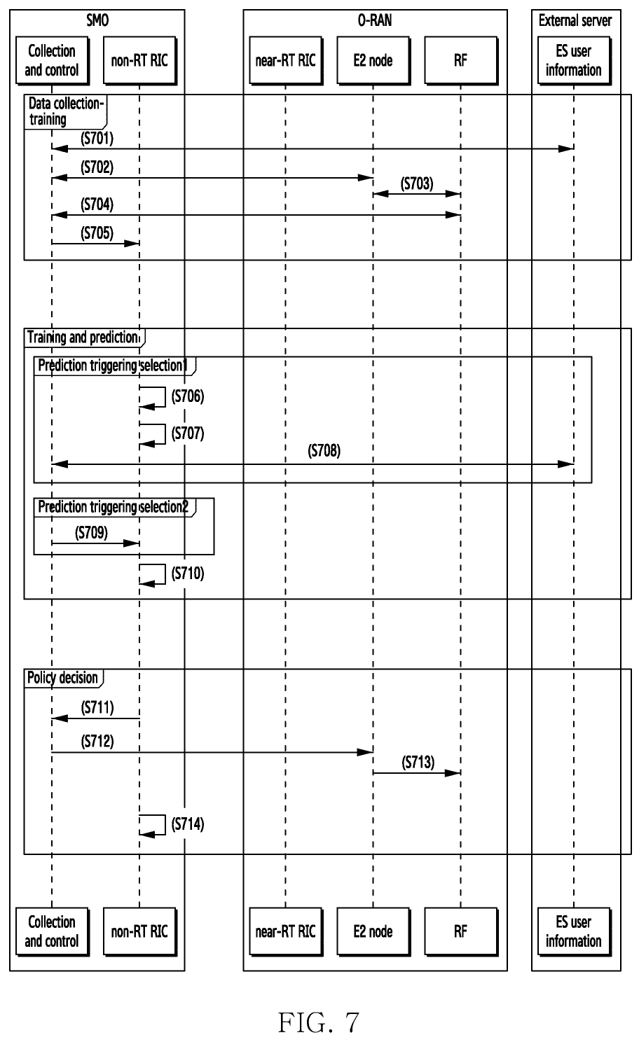

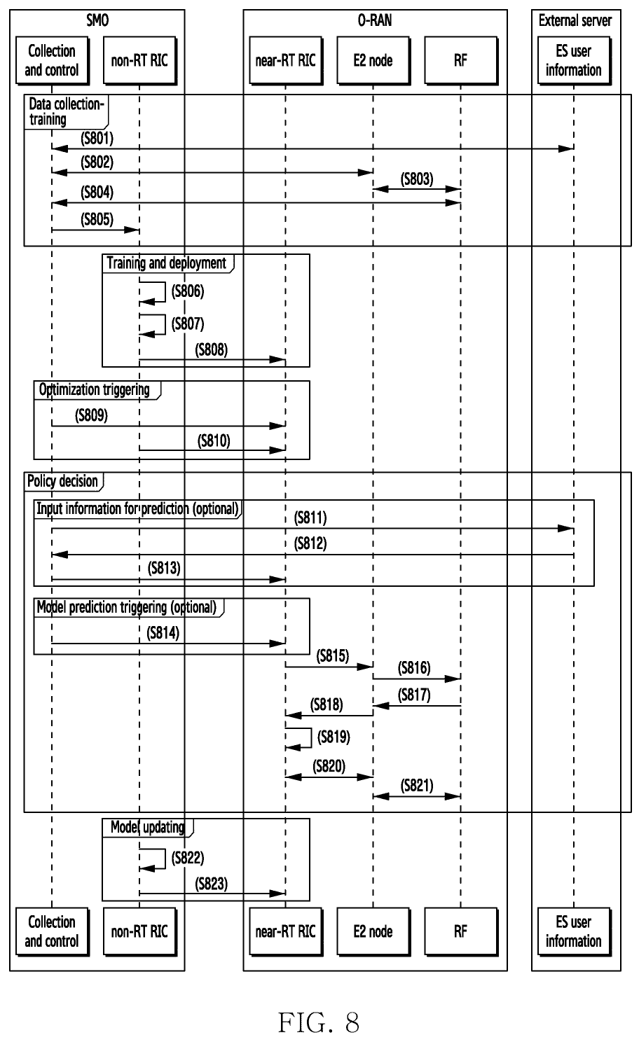

In mobile networks, mMIMO antennas are used for beamforming techniques to improve cell capacity and throughput. To achieve beamforming, an O-RU needs to concentrate PAs on a radome by combining RF elements. At low load, i.e. when the expected traffic load or number of users in connected state is below a configured threshold, energy savings can be achieved by reducing the power consumption of the O-RU by switching off certain transmit (Tx)/receive (Rx) arrays. For example, 32 out of 64 Tx/Rx arrays of the O-RU may be turned off in the digital mMIMO architecture, and accordingly the number of spatial layers and SSBs may be reduced. In some solutions, the input of the training data set of the AI/ML model does not consider the relevant measurement data of the user's SU/MU MIMO, resulting in that the user's channel state changes are not taken into account when some Tx/Rx arrays are turned off, thus causing the user throughput to drop sharply over time, degrading the system performance and reliability. To at least solve this problem, some embodiments according to the disclosure provide an energy saving scheme of RF channel reconfiguration considering user SU/MU MIMO mode switching. The energy saving scheme of RF channel reconfiguration can take full advantage of the large data scale learning advantage of the AI/ML model, adding relevant measurement data of user SU/MU MIMO as a model input, thereby solving the problem that user throughput drops sharply over a certain time, thus guaranteeing reliable transmission of user data while saving energy. The energy saving scheme of the channel reconfiguration considering user SU/MU MIMO mode switching according to some embodiments of the disclosure will be described below in connection with FIGS. 7 and 8.

FIG. 7 illustrates a flow diagram of a method of RF channel reconfiguration in an O-RAN energy saving scheme (Non-RT RIC deployment), according to an embodiment of the disclosure.

Referring to FIG. 7, through operations S701 to S703, a SMO entity may collect information (which may also be referred to as energy saving related information or energy saving related data in the disclosure) related to energy saving (e.g., network energy saving).

Operation S701 includes collection of external data (e.g., for model training). The SMO entity collects user scenario related information from an application server (e.g. edge server), for example, a movement speed of a user, a movement direction of the user, user location information, and/or the like.

Operations S702-S704 include collection of measurement data (e.g., for model training). The SMO entity may collect energy saving related information from an E2 node and an O-RU via the E2 node and an O-FH interface. Alternatively, the SMO entity may collect energy saving related information from the O-RU directly via the O-FH. For example, the energy saving related information may include one or more of information regarding uplink and/or downlink data flow per slice, information regarding measurement per SSB per cell, information regarding power consumption of the O-RU, and/or the like.

Operation S705 includes data transmission (e.g., for model training). A Non-RT RIC retrieves the collected measurement data for processing.

Operation S706 includes training and deployment of the model. The Non-RT RIC trains an AI/ML model for predicting a RF channel reconfiguration based on the collected data information. For example, the RF channel reconfiguration includes a configuration of the maximum number of SU/MU MIMO layers, selection of an O-RU transmit/receive matrix (e.g., selecting 8T8R out of 64T64R), etc. The trained AI/ML model is deployed at the Non-RT RIC and activated.

Operations S707-S708 include prediction trigger 1: trigger model prediction by monitoring energy savings. The Non-RT RIC continuously monitors the performance and energy consumption of the E2 node and O-RU for inference. For example, the performance and energy consumption related information of the E2 node and the O-RU may include cell load related information and traffic information, EE/EC measurement reports, geographical location information, and/or the like.

Operation S709 includes prediction trigger 2: Trigger prediction by selection of an energy saving mode. The Non-RT RIC triggers prediction based on the energy saving mode of RF channel reconfiguration selected by the SMO.

Operation S710 includes AI/ML model prediction. The Non-RT RIC trains the AI/ML model based on the collected data, and activates prediction of the AI/ML model based on prediction trigger 1 or prediction trigger 2.

Operation S711 includes preparing and performing RF channel reconfiguration. From the inference of the AI/ML model, the Non-RT RIC may request the SMO to configure the E2 node (O-DU) and perform RF channel reconfiguration for energy saving optimization.

Operations S712-S713 include updating the E2 node and O-RU configuration. The SMO indicates/instructs the E2 node via an O1 to perform the request received from the Non-RT RIC. The reconfiguration content of the RF channel may include one or more of: 1) selection of the O-RU TX/RX antenna array; 2) modifying the maximum number of layers for SU/MU MIMO; 3) modifying the number of SSB beams; 4) modifying O-RU antenna transmit power.

Operation S714 includes performance monitoring of the AI/ML model. The Non-RT RIC continuously analyzes the performance of the AI/ML model. If the energy saving target is not reached, it may decide to initiate a fallback mechanism and/or AI/ML model update or retraining.

An example of input data for the AI/ML model described in connection with FIG. 7 is shown in Table 7. An example of the output data of the AI/ML model is shown in Table 8. The information elements listed in Tables 7 and 8 are merely examples. The input data for the AI/ML model may include one or more of the information elements shown in Table 7, or may include other information elements. The output data of the AI/ML model may include one or more of the information elements shown in Table 8, or may include other information elements.

TABLE 7
Example of input data for AI/ML Model

| Information Element/ | | |
|---|---|---|
| Group Name | Presence | Semantic Description |
| Uplink and/or downlink | Yes | Uplink and/or downlink |
| data volume between | | data volume from O-CU- |
| O-CU-UP to O-DU | | UP to O-DU per PLMN, |
| | | per QoS level, per |
| | | slice, per interface |
| | | (F1-U, Xn-U, X2-U) |
| SSB Measurement Data | Yes | RSRP/RSRQ/SINR |
| | | measurement per SSB per |
| | | cell |
| O-RU Energy Consumption | Yes | Energy consumption of |
| | | O-RU, kWh |
| Hardware Energy | Yes | Energy consumption of |
| Consumption | | hardware components, W |
| Transmit Power | Yes | Transmit power, mW |
| Over the Air O-RU | Yes | Over the air energy |
| Energy Efficiency | | efficiency of O-RU as |
| | | calculated in O-DU |
| Number of users in | Yes | Number of RRC_{—} |
| connected state in | | CONNECTED users per |
| NG-RAN | | cell |
| >SU/MU MIMO related | Yes | MIMO related |
| measurements | | measurements |
| >>SU/MU MIMO average | Yes | Mean measurements |
| number of uplink and/ | | |
| or downlink transmission | | |
| layers and number of | | |
| PRBs | | |
| >>SU/MU MIMO average | Yes | Average utilization |
| uplink and/or downlink | | measurement |
| PRB utilization | | |
| >>SU/MU MIMO average | Yes | Average throughput |
| uplink and downlink | | measurement |
| throughput | | |
| >>Number of SRS- | Yes | Antenna switching |
| TxPortSwitches | | capability: whether |
| supported by user | | configured for antenna |
| | | switching and the type |
| | | of switching supported |
| | | SRS-TxPortSwitch = |
| | | tlrl, tlr2, tlr4 |
| >>Number of Type1/Type2 | Yes | Codebook capability |
| codebooks supported by | | supported by user |
| user | | |
| >>Number of oneFL- | Yes | User capability |
| DMRS-TwoAdditionalDMRS- | | |
| DL supported by user | | |
| UE External Information | Optional | Movement speed, |
| | | movement direction, |
| | | orientation, |
| | | acceleration, and/or |
| | | the like of the user, |
| | | which are obtained |
| | | through GPS |

TABLE 8
Example of output data of AI/ML model

| Information Element/ | | |
|---|---|---|
| Group Name | Presence | Semantic Description |
| Array selection of O-RU | Yes | Recommended Tx/Rx array |
| | | selection of O-RU (e.g. |
| | | 32T32R from 64T64R) for |
| | | energy saving |
| Maximum number of SU/MU | Yes | Used for determining the |
| MIMO spatial streams and | | number of spatial streams |
| data layers | | and the number of data |
| | | layers that can be used |
| | | for SU/MU MIMO |
| O-RU antenna transmit | Yes | O-RU antenna transmit |
| power | | power, W |
| O-RU SSB and CSI-RS TRS | Yes | Reconfiguration of |
| configuration | | reference signal |
| Confirmation Message | Yes | Confirmation message |
| (success/failure) | | (success/failure) event |
| | | triggered |

FIG. 8 illustrates a flow diagram of determination of an energy saving method of RF channel reconfiguration in an O-RAN energy saving scheme (Near-RT RIG deployment), according to an embodiment of the disclosure.

Referring to FIG. 8, through operations S801-S803, a SMO entity may collect information (which may also be referred to as energy saving related information or energy saving related data in the disclosure) related to energy saving (e.g., network energy saving).

Operation S801 includes collection of external data (e.g., for model training). The SMO entity collects user scenario related information from an application server (e.g. edge server), for example, a movement speed of a user, a movement direction of the user, user location information, and/or the like.

Operations S802-S804 includes collection of measurement data (e.g., for model training). The SMO entity collects energy saving related information from an E2 node and an O-RU (via the E2 node and O-FH interface). Alternatively, the SMO entity may collect energy saving related data from the O-RU directly via the O-FH, for example, information regarding uplink and/or downlink data flow per slice, measurement information per SSB per cell, information regarding power consumption of the O-RU and/or the like.

Operation S805 includes data transmission (e.g., for model training). A Non-RT RIC retrieves the collected measurement data for processing.

Operation S806 includes model training. The Non-RT RIC trains an AI/ML model for predicting RF channel reconfiguration based on the collected data information. For example, RF the channel reconfiguration may include a configuration of the maximum number of SU/MU MIMO layers, selection of an O-RU transmit/receive matrix (e.g., selecting 8T8R out of 64T64R), and/or the like. The trained AI/ML model is deployed at the Non-RT RIC and activated.

Operation S807 includes energy saving performance monitoring. The Non-RT RIC continuously monitors the performance and energy consumption of the E2 node and RF for inferences, such as cell load related information and traffic information, energy saving performance measurement reports, geographical location, and/or the like.

Operation S808 includes deployment of the model. The trained AI/ML model is deployed at a Near-RT RIC via the SMO over the O1 or O2 interface and activated.

Operations S809-S810 include optimization trigger. The SMO may trigger RF channel reconfiguration in the Near-RT RIC via the O1 interface, or optionally, the Non-RT RIC may provide a policy via an A1 interface to direct the Near-RT RIC RF channel to reconfigure energy saving function.

Operations S811-S813 include input information collection for model prediction (optional). The SMO continuously collects external user scenario related information, for example, a movement speed of a user, a movement direction of the user, user location information, and/or the like. The external user scenario related information may be transmitted to the Near-RT RIC.

Operation S814 includes triggering model prediction (optional). The prediction is triggered by the selection of an energy saving mode. The Near-RT RIC triggers prediction based on the energy saving mode of RF channel reconfiguration selected by the SMO.

Operations S815-S818 include data collection for model prediction. The Near-RT RIC continuously monitors 1) performance and energy consumption of the E2 node, and 2) energy consumption information of the O-RU, and collects relevant information as input information for AI/ML model prediction.

Operations S819-S821 include model prediction and performing configuration. Based on the AI/ML inference in Near-RT RIC, the Near-RT RIC may request the E2 node to prepare and perform the RF channel reconfiguration in view of the optimization strategy. The E2 node may request the O-RU to prepare and perform RF channel reconfiguration modification such as: O-RU transmit/receive matrix array selection, modification of the maximum number of SU/MU MIMO spatial streams, modification of the number of SSB beams, and/or modification of the antenna transmit power of the O-RU.

Operations S822-S823 include performance monitoring of the AI/ML model. The Non-RT RIC continuously analyzes the performance of the AI/ML model. If the energy saving target is not reached, it may decide to initiate a fallback mechanism and/or AI/ML model update or retraining, and deploy the retrained model to the Near-RT RIC.

The input data and output data of the AI/ML model of the Near-RT RIC deployment scheme described in connection with FIG. 8 may be the same as the input data and output data of the AI/ML model of the Non-RT RIC deployment described in connection with FIG. 7. An example of the input data of the AI/ML model is shown in Table 7. An example of the output data of the AI/ML model is shown in Table 8. The information elements listed in Tables 7 and 8 are merely examples. The input data for the AI/ML model may include one or more of the information elements shown in Table 7, or may include other information elements. The output data of the AI/ML model may include one or more of the information elements shown in Table 8, or may include other information elements.

An O-RU and an E2 nodes (O-CU or O-DU) may implement various sleep modes. One or more sleep modes may be enabled by a Non-RT RIC/SMO and/or Near-RT RIC. After the one or more sleep modes are enabled, the E2 node selects at least one of the one or more sleep modes based on its function, actual traffic conditions, and network conditions. Different sleep modes may run at different time granularity (e.g., symbols, slots, frames). In one approach, the input of the AI/ML training data set does not consider the reference signal related configuration and measurement information, resulting in that the reference signal variation of the cell and user is not considered when the time-frequency is turned off at the time granularity, thus causing the user throughput to drop sharply over time, degrading the system performance and reliability.

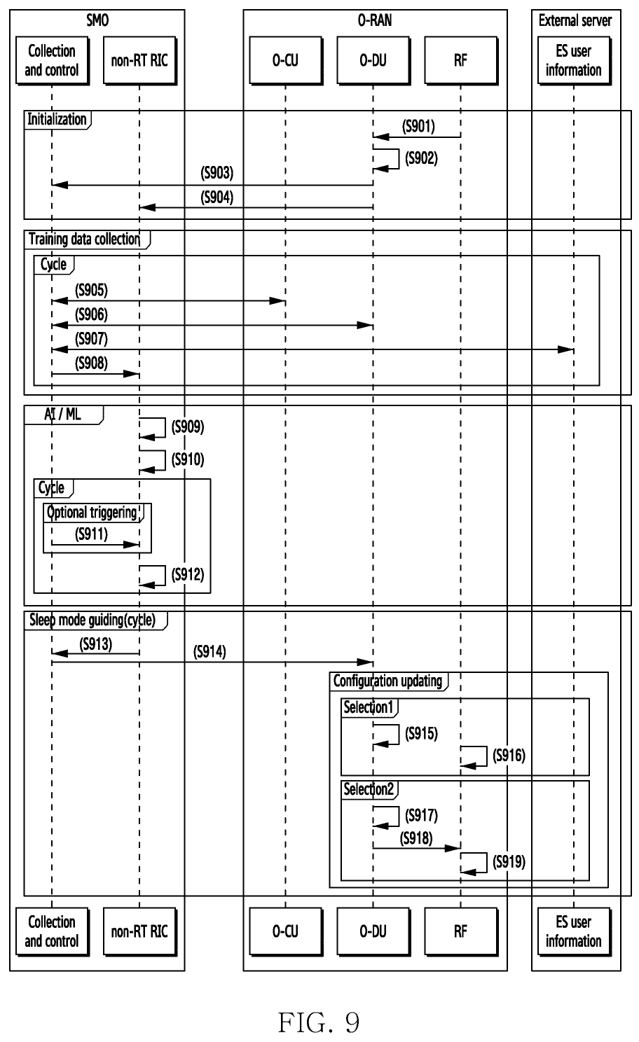

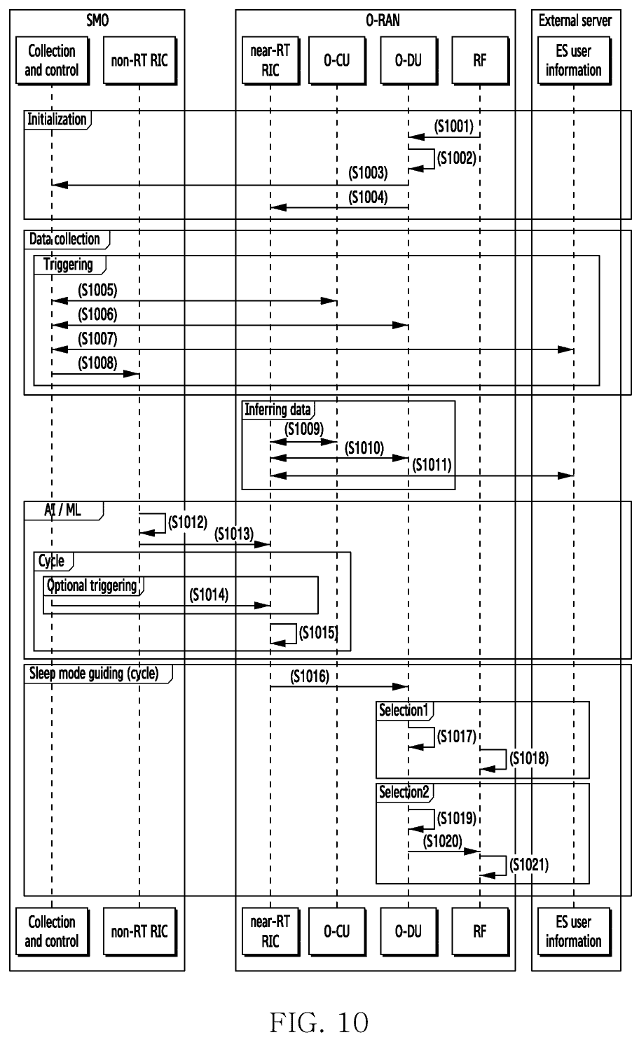

To at least address the above problems, some embodiments according to the disclosure provide an advanced sleep mode energy saving scheme that considers reference signal configuration. This scheme can take full advantage of the large data scale learning advantage of the AI/ML model, adding related configuration and measurement data of cell and user reference signals as model input, thereby solving the problem of system reliability as well as user throughput degradation upon resource reallocation, thus guaranteeing reliable transmission of user data while saving energy. The advanced sleep mode energy saving scheme considering reference signal configurations will be described below in connection with FIGS. 9 and 10, respectively.

FIG. 9 illustrates a flow diagram of an energy saving method of an advanced sleep mode (ASM) and determination of a corresponding configuration in an O-RAN energy saving scheme (Non-RT RIC deployment), according to an embodiment of the disclosure.

Operations S901 to S902 include sleep mode determination. An O-RU transmits its sleep mode capability to an O-DU. The O-DU decides to select, from multiple O-RU sleep mode capabilities, a set of O-DU/O-RU sleep capabilities to use during operation.

Operations S903 to S904 include transmission of O-RU sleep mode capability. The O-DU transmits information regarding available O-DU/O-RU sleep capabilities to a Non-RT RIC/SMO, including minimal operational information.

Operations S905-S908 include data collection and transmission. Data collection requests are transmitted from the SMO to the E2 node and/or external entities for training and inference. Data is collected from the E2 node and/or external entities for training by the SMO/Non-RT RIC. The Non-RT RIC retrieves the data for training and inference.

Operations S909-S912 include AI/ML model training, deployment, and inference. Based on continuously/periodically collected data, the Non-RT RIC trains an AI/ML model and deploys the trained AI/ML model. The Non-RT RIC performs inference using the AI/ML model. Alternatively, the recommendation may be an energy saving mode selected by the SMO, i.e. the SMO determines to recommend an advanced sleep mode, and triggers the execution of the AI/ML model prediction.

Operations S913-S914 include the transmission of the recommended sleep mode. The Non-RT RIC provides a sleep mode usage guidance to the O-DU via the SMO and O1.

Operations S915-S916 include sleep mode configuration update (optional). The O-DU takes into account the sleep mode guideline of the Non-RT RIC in its updated scheduling policy (operation S915), and the O-RU applies the configuration of sleep mode selection internally (operation S916).

Operations S917-S919 include sleep mode configuration update (optional). According to the sleep mode guideline of the Non-RT RIC, the O-DU selects a sleep mode (operation S917), the O-DU requests the O-RU to update the sleep mode configuration via the O-FH (operation S918), and the O-RU applies the new sleep mode configuration (operation S919).

In some implementation, the input of the AI/ML model may include one or more of the following: SU/MU MIMO related measurements, uplink and/or downlink data volume between O-CU-UP and O-DU, an O-RU capability (supported sleep mode), information regarding energy consumption of the O-RU, and/or the like.

In some implementation, the output of the AI/ML model may include one or more of selection of a sleep mode and the configuration of the sleep mode, etc.

FIG. 10 illustrates a flow diagram of an energy saving method of the ASM and determination of a corresponding configuration in an O-RAN energy saving scheme (Near-RT RIC deployment), according to an embodiment of the disclosure.

Operations S1001 to S1002 include sleep mode determination. The O-RU transmits its sleep mode capability to the O-DU. The O-DU decides to select, from multiple O-RU sleep mode capabilities, a set of O-DU/O-RU sleep capabilities to use during operation.

Operations S1003-S1004 include transmission of O-RU sleep mode capability. The O-DU transmits information regarding available O-DU/O-RU sleep capabilities to a Near-RT RIC/SMO, including minimal operational information.

Operations S1005-S1008 include data collection (training) and transmission. Data collection requests are transmitted from the SMO to an E2 node and/or external entities for training and inference. Data is collected from the E2 node and/or external entities for training by the SMO/Non-RT RIC. The Non-RT RIC retrieves data for training.

Operations S1009-S1011 include data collection (inference) and transmission. Data collection from the Near-RT RIC to the E2 node and/or external entities is used for model inference.

Operations S1012-S1015 include AI/ML model training, deployment, and prediction. Based on continuously/periodically collected data, the Non-RT RIC trains an AI/ML model and deploys it to Near-RT RIC via an O1/O2. The Near-RT RIC performs inference using the AI/ML model. Optionally, in operation S1014, the recommendation may be an energy saving mode selected by the SMO, i.e. the SMO determines to recommend an advanced sleep mode, and triggers the execution of the AI/ML model prediction.

Operation S1016 includes transmission of sleep mode configuration guidance. A sleep mode guidance provided by the Near-RT RIC is transmitted to the O-DU via the E2 interface.

Operations S1017-S1018 include sleep mode configuration update (optional). The O-DU takes into account the sleep mode guidance of the Near-RT RIC in its updated scheduling policy, and the O-RU applies the configuration of the sleep mode selection internally.

Operations S1019-S1021 include sleep mode configuration update (optional). According to the sleep mode guideline of the Near-RT RIC, the O-DU selects a sleep mode (operation S1019), the O-DU requests the O-RU to update the sleep mode configuration via the O-FH (operation S1020), and the O-RU applies the new sleep mode configuration (operation S1021).

The input data and output data of the AI/ML model of the Near-RT RIC deployment scheme described in connection with FIG. 10 may be the same as the input data and output data of the AI/ML model of the Non-RT RIC deployment described in connection with FIG. 9.

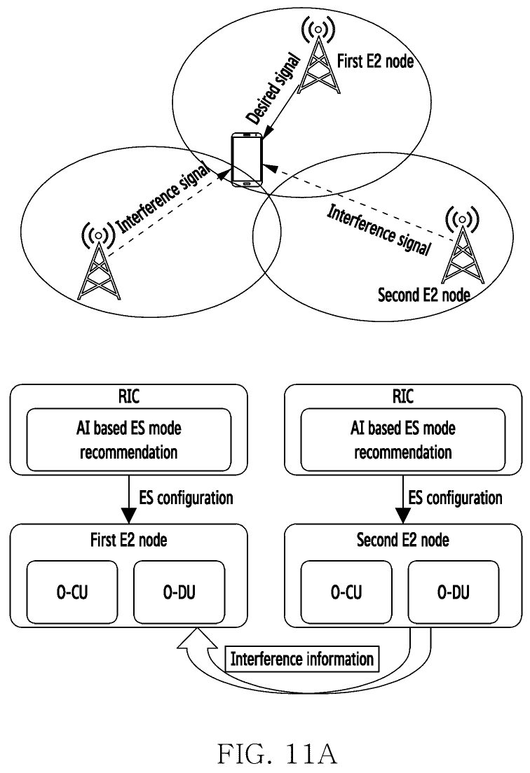

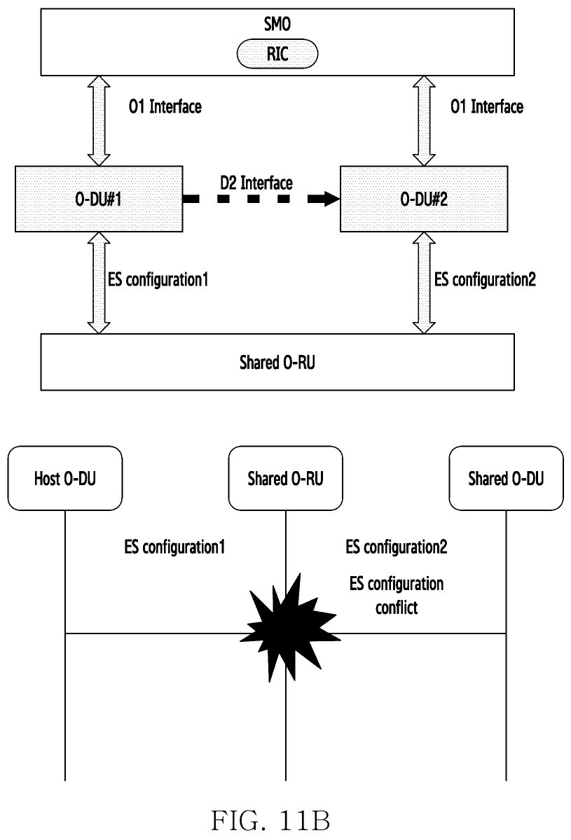

FIGS. 11A and 11B illustrate schematic diagrams of interference between multiple O-DUs in an O-RAN energy saving scheme and the impact of interference on energy saving configurations, according to various embodiments of the disclosure. Referring to FIG. 11A, there may be interference between multiple O-DUs. Since the interference among the O-DUs will cause a reduction in SINR, thus reducing the modulation coding scheme (MCS) and transmission efficiency, the same traffic will require longer transmission time, which will affect the energy saving efficiency. If a Non-RT RIC/Near-RT RIC determines an energy saving mode based only on information of the individual O-DUs/O-RU, the accuracy of the energy saving mode recommendation will be reduced due to the lack of information regarding interferences among the O-DUs. Also, training or deploying a separate AI model in the Non-RT RIC/Near-RT RIC for each energy saving mode of a separate O-DU increases the training cost.

Referring to FIG. 11B, in the shared O-RU structure, if the Non-RT RIC/Near-RT RIC trains AI models based on the information of individual O-DUs and O-RU, respectively, it results in multiple O-DUs configuring conflicting energy saving modes to the O-RU at the same time. For example, there is a case where the Non-RT RIC/Near-RT RIC recommends that the host O-DU adopt the energy saving mode of the RF antenna off, but recommends that the slave O-DU adopt the mode of RF antenna fully-on. When the O-RU receives the two conflicting energy saving modes, the O-RU will maintain the current state with little or no energy saving efficiency.

Some embodiments of the disclosure propose a method of training one Al model based on all O-DUs/O-RUs and all energy saving modes to configure accurate energy saving modes for all O-DUs/O-RUs. For example, the AI model may be trained based on (e.g., using) training data (e.g., data described in various embodiments of the disclosure that may be used to train the AI model) (e.g., including information regarding interferences among the O-DUs) for all energy saving modes (e.g., all of one or more energy saving modes) and all O-DUs/O-RUs (e.g., all of one or more O-DUs associated with (e.g., connected to) the O-RU under shared O-RU structure (e.g., where the one or more O-DUs share the O-RU)). For example, the AI model may be configured to (or trained to) output a recommended energy saving configuration for each O-DU based on an input (e.g., the input may include information regarding one or more energy saving modes and one or more O-DUs/O-RU (e.g., all of one or more O-DUs associated with (e.g., connected to) the O-RU under shared O-RU structure (e.g., where the one or more O-DUs share the O-RU)).

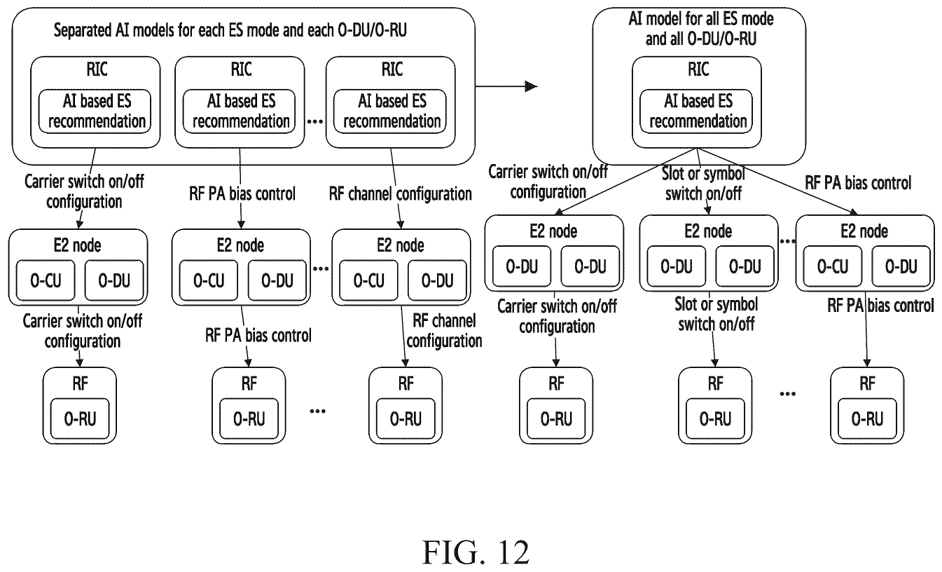

FIG. 12 shows comparative examples of training an AI model for energy saving recommendation separately for each O-DU/O-RU and one AI model for energy saving recommendation for all O-DUs/O-Rus according to an embodiment of the disclosure. Referring to FIG. 12, the AI model of RIC may generate respective recommended energy saving configurations (e.g., cell or carrier switch off, ASM, or PA bias control) for the corresponding E2 node. In this way, the RIC may train one Al model to accurately configure energy saving configurations for different O-DUs. The RIC may collect all energy saving related configuration information for all O-DUs/O-RUs, including information regarding interferences among the O-DUs, to train the Al model. It needs to be noted that the energy saving configuration (e.g., cell or carrier switch off, ASM, or PA bias control) illustrated in FIG. 12 is only an example, and the energy saving configuration in various embodiments of the disclosure may be employed.

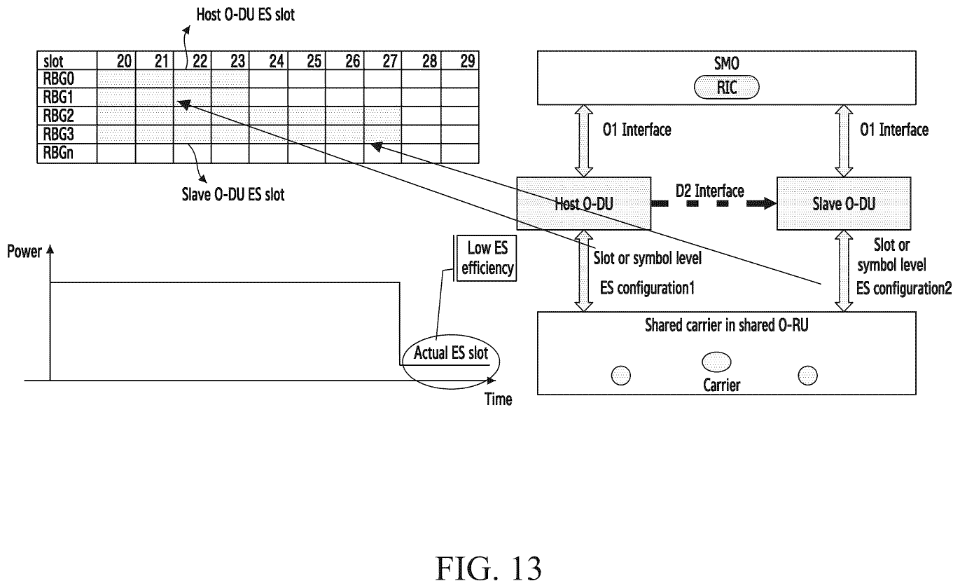

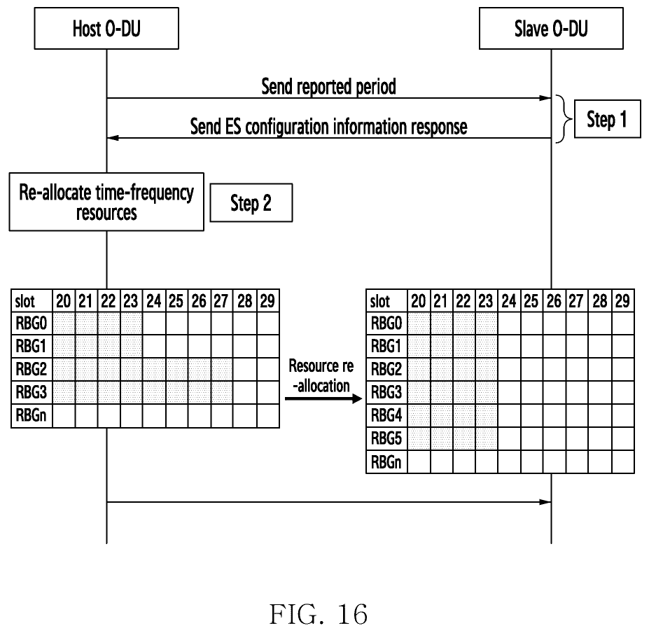

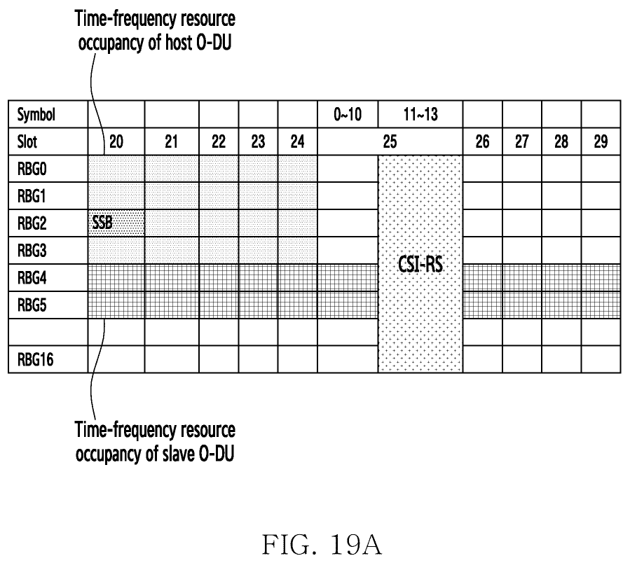

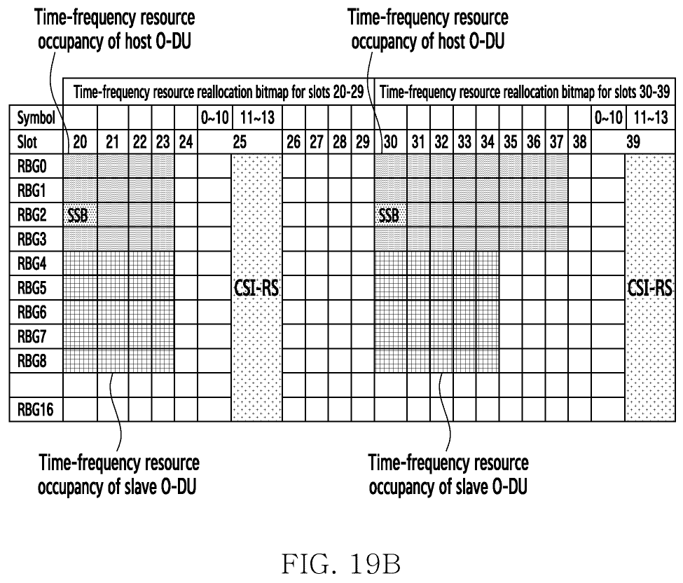

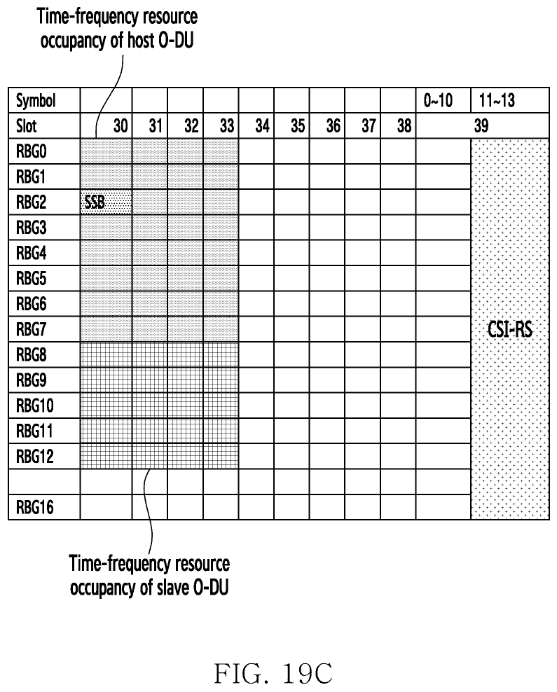

Due to the small time granularity of the ASM energy saving mode, the specific energy saving configuration may only be determined at the O-DU side. FIG. 13 illustrates an example of an inefficient energy saving configuration under shared carrier in shared O-RU structure in an O-RAN energy saving scheme, according to an embodiment of the disclosure. Referring to FIG. 13, “slot” denotes a slot that is a time-domain resource unit, and “RBG” denotes a resource block group that is a frequency-domain resource unit, and such naming/indication may be applied to FIGS. 16 and 19A through 19C to be described below. Referring to FIG. 13, the energy saving slots of the host O-DU are slots 20-23 and the corresponding resources are RBG 0 and RBG1; the energy saving slots of the slave O-DU are slots 20-27 and the corresponding resources are RBG2-RBG3. Referring to FIG. 13, in a scenario where the O-RU is shared and the host O-DU and the slave O-DU share a carrier, when the Non-RT RIC/Near-RT RIC configures both the host O-DU and the slave O-DU with ASM, the shared O-RU may achieve energy saving only at the intersection of energy saving slots or symbols of all O-DUs (e.g., in slots 20-23) due to the symbol-level or slot-level energy saving configuration of the individual O-DUs according to the received information, resulting in energy saving inefficiency. It is noted that in some embodiments of the disclosure, the energy saving mode/setting may be described in terms of a symbol or a slot as a time unit, and the energy saving mode/setting may be described in terms of a resource block group (RBG) as a frequency domain unit, however the disclosure is also applicable to energy saving settings for other time units or frequency domain units. For example, in FIG. 13, 16, 19A, 19B, or 19C, the “slot” may be replaced with other time domain resources, such as symbol(s), subslot(s), mini-slot(s), or subframe(s); the “RBG” may be replaced with other frequency domain resources such as channel(s), subchannel(s), carrier(s), subcarrier(s), resource block(s) (RB(s)), resource element(s) (RE(s)), physical resource block(s) (PRB(s)). In embodiments of the disclosure, the time-frequency resource may include a time domain resource and/or a frequency domain resource.

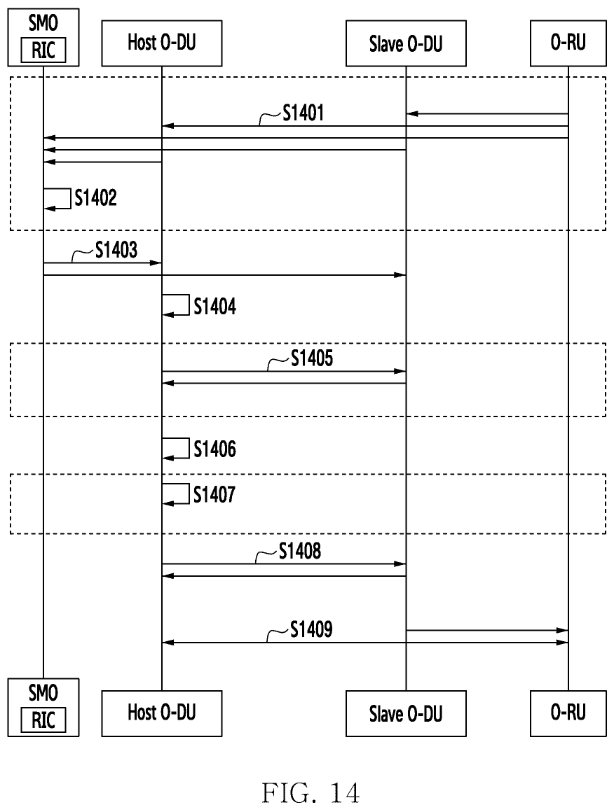

FIG. 14 illustrates a determination flow of an energy saving configuration in an O-RAN energy saving scheme (Non-RT RIC/Near-RT RIC deployment), according to an embodiment of the disclosure. The method described in connection with FIG. 14 is merely an example, and some steps may be omitted or some new steps may be added. Referring to FIG. 14, the RIC is collectively referred to as Non-RT RIC/Near-RT RIC.

Referring to FIG. 14, in operation S1401, the SMO entity may collect information regarding energy saving (e.g., network energy saving) (which may also be referred to as energy saving related information or energy saving related data in this disclosure) of one or more O-DUs/O-RU (e.g., under shared O-RU structure, an O-RU and one or more O-DUs associated with (e.g., sharing) the O-RU). Information reported by the O-RU may include an O-RU type, an identification or identifier (ID) of an O-DU controlling the O-RU, a PA bias level supported by the O-RU, and/or the like; information reported by the O-DU may include interferences among the O-DUs, and/or the like.

In operation S1402, an energy saving mode is configured by using a trained AI model (e.g., AI model for energy saving (e.g., recommending an energy saving configuration)). The RCI may train the AI model (AI model for energy saving (e.g., recommending an energy saving configuration)) to obtain the trained AI model. The RIC may train the AI model based on training data to recommend an accurate or suitable energy saving mode and/or energy saving configuration. For example, the training data may include collected (e.g., previously collected) information of all O-DUs/O-RUs and information of all energy saving modes, which may include the O-RU type, the ID of the O-DU controlling the O-RU, the PA bias level supported by the O-RU, and/or the like, and/or the interferences among the O-DUs, and/or the like. For example, the AI model may be configured to (or trained to) output a recommended energy saving mode and/or energy saving configuration for each O-DU based on the input (e.g., the input may include collected information of all O-DUs/O-RUs and information of all energy saving modes (e.g., under shared O-RU structure, information regarding an O-RU and all of one or more O-DUs associated with (e.g., sharing) the O-RU), including the O-RU type, the O-DU ID controlling the O-RU, the PA bias level supported by the O-RU, and/or the like). The ES mode of PA bias control is introduced in ORAN to support gaps in frequency domain ES modes, so as to better balance user QoS and energy saving efficiency.

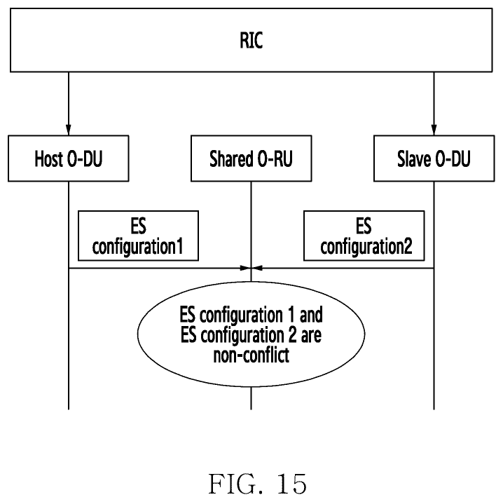

FIG. 15 illustrates a flow diagram of energy saving mode determination in a multi-O-DU scenario or a non-conflicting energy saving mode in a shared O-RU scenario in an O-RAN energy saving scheme (Non RIC/Near-RT RIC deployment), according to an embodiment of the disclosure.

Referring to FIG. 15, an optimal PA bias control level is configured for the O-RU to affect frequency domain resources through dynamic power adjustment and to save energy without affecting user QoS. In the shared O-RU structure, as shown in FIG. 15, the RIC determines the relationship among the O-DUs by the O-RU type and the ID of the O-DU controlling the O-RU, thereby configuring a non-conflicting energy saving mode (e.g., energy saving configuration 1 and energy saving configuration 2 are not conflicting) to all O-DUs (e.g., host O-DU and slave O-DUs) sharing one O-RU.

Referring back to FIG. 14, in operation S1403, the RIC sends the energy saving mode to all O-DUs.

In operation S1404, it is determined whether the slave O-DU needs information reporting. If the type reported by the O-DU is shared carrier in shared O-RU and the energy saving mode of the host O-DU is the ASM, continue to operation S1405, otherwise jump to operation S1409.

In operation S1405, information is interacted between the host O-DU and the slave O-DU. The host O-DU sends a reported period to the slave O-DU, and the slave O-DU needs to periodically report time-frequency resource information (time-frequency resource pattern/bitmap), remaining BO, traffic priority and energy saving mode, and/or the like to the host O-DU according to the reported period.

With operation S1406, the host O-DU determines whether resource reallocation/reconfiguration is required. If the energy saving mode reported by the salve O-DU is the ASM, continue with operation S1407, otherwise jump to operation S1409.

In operation S1407, the host O-DU periodically adjusts the time-frequency resources (e.g., reconfigures/re-allocates the time-frequency resources) based on the resource pre-allocation information reported by all O-DUs to maximize energy saving efficiency. For example, to enable resource reconfiguration by the host O-DU, the slave O-DU may periodically report time-frequency resource information (time-frequency resource pattern/bitmap), remaining BO, traffic priority, time-frequency resource pre-allocation information, energy saving mode, and/or the like to the host O-DU. The host O-DU reconfigures/re-allocates the time-frequency resources (e.g., periodically) using the information reported by the slave O-DU to minimize the occupation of the time-domain resources, thereby maximizing the energy saving efficiency, on the premise of guaranteeing normal traffic transmission.

FIG. 16 illustrates an example of an inefficient energy saving configuration under shared carrier in shared O-RU structure in an O-RAN energy saving scheme, according to an embodiment of the disclosure.

For example, referring to FIG. 16, prior to resource reconfiguration, the energy saving slots of the host O-DU are slots 20-23, and the corresponding resources are RBG0 and RBG1; the energy saving slots of the slave O-DU are slots 20-27 and the corresponding resources are RBG2-RBG3. With the resource reconfiguration, the energy saving slots of the host O-DU are slots 20-23, and the corresponding resources are RBG0 and RBG1; the energy saving slots of the slave O-DU are slots 20-23 and the corresponding resources are RBG2-RBG5. After the resource reconfiguration, the occupation of time domain resources is reduced (from slots 20-27 to slots 20-23), thereby improving energy saving efficiency.

Operation S1408 includes the host O-DU notifying all slave O-DUs of information regarding the reconfigured/re-allocated resources via the D2 interface.

Operation S1409 includes each O-DU notifying the O-RU of the energy saving configuration over the OFH interface.

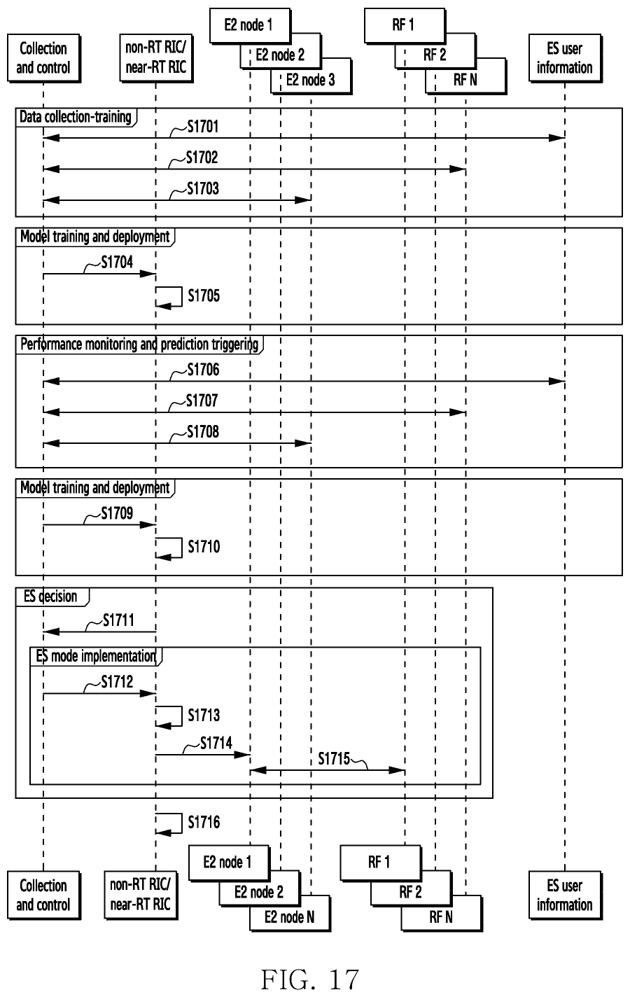

FIG. 17 further illustrates, on the basis of FIG. 14, the flow of AI model training and determination of energy saving configuration recommendations in an O-RAN energy saving scheme (Non-RT RIC/Near-RT RIC deployment), according to an embodiment of the disclosure. The method described in connection with FIG. 17 is merely an example, and some steps may be omitted or some new steps may be added.

Referring to FIG. 17, through operations S1701 to S1703, a SMO entity may collect information (which may also be referred to as energy saving related information or energy saving related data in the disclosure) related to energy saving (e.g., network energy saving) of multiple O-DUs/O-RUs.

operation S1701 includes collection of external data (e.g., for model training). In operation S1701, the SMO entity may collect user scenario related information from an application server (e.g. an edge server). For example, the user scenario related information may include one or more of a movement speed of a user, a movement direction of the user, user location information, and/or the like.

Operation S1702 includes collection of measurement data (e.g., for model training). In operation S1702, the SMO entity may collect information regarding multiple energy saving modes from multiple E2 nodes via O1 interfaces or from multiple O-RUs via O-FH interfaces. For example, information regarding the O-RU may include one or more of information of power consumption of respective hardware components of the O-RU, information regarding an O-RU transmit power, an O-RU type, ID information of an O-DU controlling the O-RU, and a PA bias supported by the O-RU. The O-RU may measure the power consumption of the hardware component and report the measured power consumption to the SMO entity. The O-RU may determine the O-RU transmit power and report the O-RU transmit power to the SMO entity. In an embodiment of the disclosure, the E2 node may include an O-DU and/or an O-CU. Operation S1703 includes collection of measurement data (e.g., for model training). In operation 1703, the SMO entity may collect information regarding multiple an energy saving modes from multiple E2 nodes via the O1 interface. For example, the information regarding the E2 node may include one or more of information regarding a cell UL and/or DL data flow, SSB signal measurement information (e.g., strength information, such as RSRQ, RSRP, SINR, etc.), a number of users in connected state, information regarding interferences among O-DUs, and/or the like. The E2 node may determine (e.g., receive from terminals it serves) and report the energy saving related information to the SMO entity.

Operation S1704 includes data transmission (e.g., for model training). In operation S1704, the SMO entity may transmit the collected data information to a Non-RT RIC/Near-RT RIC.

Operation S1705 includes AI/ML model training, deployment, and activation. In operation S1705, based on the collected energy saving related data, an AI/ML model is trained by the Non-RT RIC/Near-RT RIC. The AI/ML model is trained to determine an energy saving mode and/or user traffic load information based on the energy saving related data as input data. The trained AI/ML model may be deployed and/or activated at the Non-RT RIC. The trained AI/ML model deployed at the Non-RT RIC/Near-RT RIC may be activated to make predictions or inferences. The energy saving mode as an output of the AI/ML model may include, for example, one or more of carrier/cell switch off, RF channel off, ASM, PA bias control, and/or the like. The user traffic load information as an output of the AI/ML model may assist the E2 node in selecting an energy saving mode to apply. The E2 node can preferentially select an energy saving mode based on the user traffic load information received from the Non-RT RIC/Near-RT RIC. In the Non-RT RIC/Near-RT RIC training the AI model, the O-RU type, ID information of all O-DUs controlling the O-RU, and information regarding interferences among the O-DUs are considered. If the type reported by the O-RU is a shared O-RU, the output of the AI model recommends a non-conflicting energy saving mode for all O-DUs considering the conflict labels of Table 11 to determine the energy saving configuration of the O-RU.

Operations S1706-S1708 include energy saving performance monitoring and triggering of model prediction. The energy saving performance monitoring may be the same as operation S1701 to operation S1703 except for the time when the data is collected. Rather than operations S1701 to S1703 collecting long durations of data (e.g., measurement data over several days, such as 24 days), operations S1706-S1708 periodically monitor real-time energy saving performance data (e.g., every few minutes, such as 5 minutes). The details regarding the energy saving performance data may refer to the description of the energy saving related data in operations S1701 to S1703. In operations S1706 to S1708, the SMO may confirm whether to trigger the AI/ML model prediction function according to the monitoring data. It may be determined to trigger the AI/ML model to predict an energy saving mode and/or user traffic load information, for example, based on real-time cell traffic and inter-user interference information, and/or the like.

Operation S1709 includes data transmission for AI/ML model inference (e.g., prediction). In operation S1709, the SMO entity may transmit the collected data information for model prediction to the Non-RT RIC/Near-RT RIC for prediction of the AI/ML model at the Non-RT RIC/Near-RT RIC. For example, the collected data information may include one or more of a movement speed of a user, a movement direction of the user, user location information, O-RU measurement information, and/or the like.

Operation S1710 includes prediction by the AI/ML model. In operation S1710, the deployed AI/ML model predicts an energy saving mode and predicts user traffic load information based on the user scenario related information from the application server in real time and the energy saving related information from the E2 node and the O-RU.

Operation S1711 includes, based on the information predicted by the AI/ML model, the Non-RT RIC/Near-RT RIC asking the SMO to recommend an energy saving mode. For example, the recommended energy saving mode may include one or more of carrier/cell switch off, RF channel off, ASM, PA bias control, and/or the like.

Operation S1712 includes data transmission. In operation S1712, the SMO may transmit the selected energy saving mode and the predicted user traffic load information to the Non-RT RIC/Near-RT RIC for application of the energy saving mode.

Operation S1713 includes determining (e.g., using an AI/ML model to infer) an energy saving configuration according to the energy saving mode. The Non-RT RIC/Near-RT RIC may determine an energy saving configuration corresponding to the energy saving mode based on the energy saving mode in operation S1713. For example, an AI/ML model for inferring an energy saving configuration that has been deployed at the Non-RT RIC/Near-RT RIC (e.g., the AI/ML model may be another AI/ML model that is different from the AI/ML model described above), based on the energy saving mode confirmed by the SMO, infers a corresponding energy saving configuration. For example, in case that the SMO determines that energy saving mode is carrier/cell switch off, the AI/ML model deployed at the Non-RT RIC/Near-RT RIC for configuration of carrier/cell switch off infers the corresponding configuration of carrier/cell switch off.

Operation S1714 includes transmission of the recommended energy saving configuration and the predicted user traffic load information. In operation S1714, the recommended energy saving configuration and the predicted user traffic load information are transmitted from the Non-RT RIC to the Near-RT RIC via an Al interface, and then transmitted from the Near-RT RIC to the E2 node via the E2 interface.

Operation S1715 includes the E2 node determining an optimal energy saving configuration. The energy saving configuration derived by the E2 node based on the predicted user traffic load information (the E2 node algorithm) is compared with the recommended energy saving configuration (predicted by the AL/ML model) and finally the optimal energy saving configuration is selected.

Operation S1716 includes energy saving performance monitoring. In operation S1716, the Non-RT RIC/Near-RT RIC may continuously analyze the AI/ML model for energy saving mode prediction, which may trigger an energy saving fallback or an update and retraining of the AI/ML model if the energy saving performance target is not achieved or the system is in an unstable state (e.g., a high retransmission rate occurs).

Examples of the input data of the AI/ML model/training data for the Non-RT RIC/Near-RT RIC deployment scheme described in connection with FIG. 17 may include one or more of the information listed in one or more of Tables 1, 3, 5, 7, and 9, and examples of output data may include one or more of the information listed in one or more of Tables 2, 4, 6, 8, and 10. The information elements listed in all tables are examples only. The input data/training data for the AI/ML model may include one or more of the information elements listed in one or more or all of Tables 1, 3, 5, 7, and 9, or may include other information elements. The output data of the AI/ML model may include one or more of the information elements listed in one or more or all of Tables 2, 4, 6, 8, and 10, or may include other information elements. The information elements shown in Table 11 contain part of the AI output labels under the shared O-RU structure, and only those that conform to the output labels can be output. In some implementation, the inputs to the AI/ML model may include one or more of SU/MU MIMO related measurements, uplink and/or downlink data volume between O-CU-UP and O-DU, O-RU capability (supported sleep mode), information regarding energy consumption of the O-RU, etc.

TABLE 9
Example of input data/training data for AI/ML Model

| Information Element/ | | |
|---|---|---|
| Group Name | Presence | Semantic Description |
| Uplink and/or downlink | Yes | Uplink and/or downlink data |
| data volume between | | volume from O-CU-UP to O-DU |
| O-CU-UP and O-DU | | per PLMN, per QoS level, per |
| | | slice, per interface (F1-U, |
| | | Xn-U, X2-U) |
| SSB Measurement Data | Yes | RSRP/RSRQ/SINR measurement |
| | | per SSB per cell |
| O-RU Energy | Yes | Energy consumption of O-RU, |
| Consumption | | kWh |
| O-RU Type | Yes | O-RU type , including shared |
| | | carrier in shared O-RU/ |
| | | different carrier in shared |
| | | O-RU/separated O-RU |
| ID of O-DU controlling | Yes | ID of connected O-DU, reported |
| O-RU | | by O-RU |
| Inter-O-DU interference | Yes | CSI-based report |
| measurement information | | |

TABLE 10
Example of output data of AI/ML model

| Information Element/ | | |
|---|---|---|
| Group Name | Presence | Semantic Description |
| Recommendation of | Yes | Recommend energy saving mode |
| candidate mode for | | of carrier/cell switch off |
| energy saving | | or RF channel off or ASM or |
| | | PA bias control |
| Confirmation Message | Yes | Confirmation message (success/ |
| (success/failure) | | failure) event triggered |
| Updated energy saving | Yes | Updated energy saving |
| configuration | | configuration (e.g., activation, |
| | | deactivation, or sleep of |
| | | carrier; or RF channel off |
| | | or on, etc.) |

TABLE 11
Energy saving mode recommendation labels for AI model output
(‘✓’ represents a corresponding label that can be
output, ‘X’ represents a corresponding label that cannot be output)

| | | Different | Shared |
|---|---|---|---|
| Host O-DU | Slave O-DU | Carrier | Carrier |
| Carrier/Cell On | Carrier/Cell Off | ✓ | X |
| Carrier/Cell On | ASM | ✓ | ✓ |
| Carrier/Cell On | RF Channel On | ✓ | ✓ |
| Carrier/Cell On | RF Channel Off | X | X |
| Carrier/Cell On | PA Bias Control | ✓ | ✓ |
| Carrier/Cell Off | ASM | ✓ | X |
| Carrier/Cell Off | RF Channel On | ✓ | X |
| Carrier/Cell Off | RF Channel Off | ✓ | ✓ |
| Carrier/Cell Off | PA Bias Control | ✓ | X |
| RF Channel On | ASM | ✓ | ✓ |
| RF Channel On | PA Bias Control | ✓ | ✓ |
| RF Channel Off | ASM | X | X |
| RF Channel Off | RF Channel On | X | X |
| RF Channel Off | PA Bias Control | X | X |
| ASM | PA Bias Control | ✓ | ✓ |

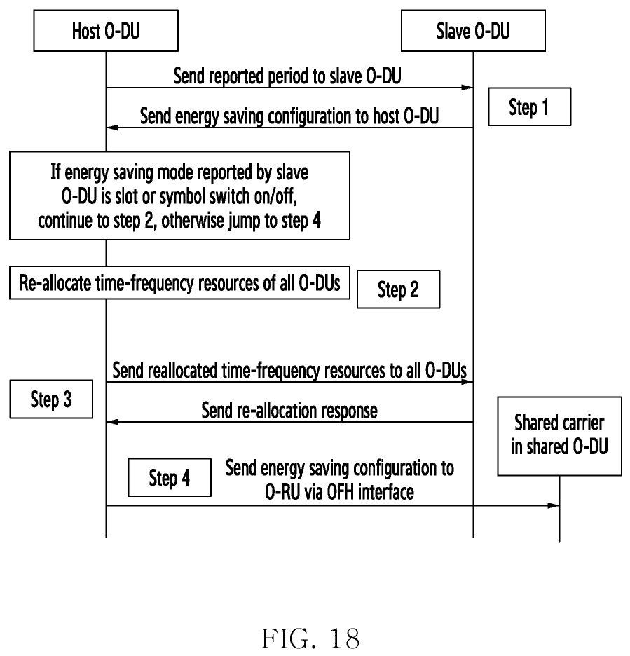

FIG. 18 illustrates a determination procedure of time-frequency resource reconfiguration/reallocation by a host O-DU under shared carrier in shared O-RU structure for O-RAN, in accordance with an embodiment of the disclosure. The method described in connection with FIG. 18 is merely an example, and some steps may be omitted or some new steps may be added. Referring to FIG. 18, RIC is collectively referred to as Non-RT RIC/Near-RT RIC. FIG. 18 describes the determination flow of further time-frequency resource reconfiguration/reallocation after the host O-DU receives an energy-saving mode recommended by the RIC as ASM energy-saving mode.

Referring to FIG. 18, in step 1, the host O-DU may send a reconfiguration period to the slave O-DU when the energy saving mode of the first received RIC configuration is the ASM. For example, the reconfiguration reported period may be 10 ms, 5 ms, 2.5 ms, or 1.25 ms. The slave O-DUs record this information upon receipt of the reconfiguration period and periodically transmits to the host O-DU the relevant information required for the reconfiguration/reallocation of the time-frequency resources. For example, the resource reconfiguration/reallocation related information may include one or more of the following:
Energy saving mode of slave O-DU. The following two reporting approaches may be included. In the first approach, the energy saving mode recommended by the RIC for the slave O-DU is directly reported. For example, all energy saving modes may be assigned numbers or indexes, respectively, and the number or index of the corresponding energy saving mode is reported. In the second approach, an indication of whether the energy saving mode of the slave O-DU is the ASM may be reported. For example, if the energy saving mode of the slave O-DU is the ASM, the indication 1 is reported, otherwise the indication 0 is reported; the resource reallocation is performed only if the energy saving modes of both the slave O-DU and the host O-DU are the ASM.
Traffic priority of slave O-DU and remaining BO for each traffic type. The traffic priority may be divided into GBR (Guaranteed Bit Rate) traffic and NGBR (Non-Guaranteed Bit Rate) traffic. If the priority of the GBR traffic is 1 and the priority of the NGBR traffic is 0, the GBR traffic transmission needs to be preferentially guaranteed.
Time-frequency resource prediction distribution pattern (e.g., a time-frequency resource bitmap or pattern) for the remaining BO of the slave O-DU and the reference signal. The reference signal may include information such as CSI-RS. The time-frequency resource distribution pattern (e.g., time-frequency resource bitmap) is preconfigured/per-allocated by each O-DU according to the current MCS (Modulation and Coding Scheme), traffic, frequency band information of the previous period.
Time-frequency resource distribution pattern (e.g., time-frequency resource bitmap or pattern) of SSB (Synchronization Signal/Physical Broadcast Channel (PBCH) block) of slave O-DU. There are two approaches to report. In the first approach, the time-frequency resource distribution information of the SSB is reported per period. In the second approach, the time-frequency resource distribution information of the SSB is reported on the first period, and the host O-DU records the information after receiving it, and then it is not reported, because the time-frequency resource of the SSB is fixed after the cell set up.
Optional information: bandwidth of slave O-DU. In slicing scenario, the time-frequency resource information after reconfiguration/reallocation by the host O-DU cannot exceed the maximum bandwidth to which the slave O-DU is allocated.

Referring to FIG. 18, after step 1 is completed, the host O-DU needs to determine whether the energy saving mode of the slave O-DU is the ASM. If yes, proceed to step 2, otherwise each O-DU separately sends an energy saving configuration to the shared O-RU.

Referring to FIG. 18, in step 2, the host O-DU utilizes the information reported in step 1 for time-frequency resource reconfiguration/reallocation to maximize energy saving efficiency without affecting normal traffic transmission. The basic principle of time-frequency resource re-allocation includes one or more of the following:
Ensure normal transmission of GBR traffic. The priority of the GBR traffic is high, and in order to ensure normal transmission of the GBR, the reconfiguration/reallocation of the time-frequency resources of the GBR traffic should be minimized. The time-frequency resources of the NGBR service need to be reconfigured first at the time of reconfiguration/reallocation.
No change for time-frequency resources of reference signal. The reference signal includes signals such as SSB and CSI-RS. The time-frequency resources of the reference signal should not be reconfigured.
The reconfigured frequency domain resource occupancy should not be greater than the maximum bandwidth of the slave O-DU. In the slicing scenario, since the bandwidth resources of the slave O-DU may be limited, the limitation of the maximum bandwidth needs to be considered in the process of resource reconfiguration/reallocation.
Reconfigure the time-frequency resources on the principle of minimum time domain resource occupancy and low-priority traffic prioritization reconfiguration. Time-frequency resources for low priority traffic are reconfigured first, occupying the few slots or symbols as possible to maximize the energy saving efficiency.

Referring to FIG. 18, in step 3, the host O-DU sends the information regarding the reconfigured time-frequency resource to the slave O-DU, which refers to the information regarding the reallocated time-frequency resources for the scheduling of the current period. The slave O-DU replies with a reconfiguration response, by sending information indicating that the reconfiguration was successful (e.g., ‘1’) if the reconfiguration was successful, and otherwise, sending information indicating that the reconfiguration was unsuccessful (e.g., ‘0’).

Referring to FIG. 18, in step 4, each O-DU sends a specific energy saving configuration to the O-RU. For example, the energy saving configuration may indicate one or more slots or symbols in which energy saving is to be turned off. For example, the O-RU may determine which slots or symbols to turn off based on the energy saving configuration.

FIGS. 19A, 19B, and 19C illustrate schemes for maximizing energy saving efficiency for time-frequency resource reconfiguration by a host O-DU under shared carrier in shared O-RU structure for O-RAN, according to various embodiments of the disclosure. The assumption of FIGS. 19A, 19B, and 19C is premised on the energy saving mode of a host O-DU and a slave O-DU being ASM under shared carrier in shared O-RU structure for O-RAN (embodiments of the disclosure are not limited thereto and may be applicable to other energy saving modes). The schemes described in connection with FIGS. 19A, 19B, and 19C are only examples, and various vendors may achieve slot or symbol off energy savings through different time-frequency resource adjustment schemes. The assumed reconfiguration cycle is 10 slots. Referring to FIGS. 19A, 19B, and 19C, the horizontal axis represents time domain resources, e.g., in units of slots or symbols, and the vertical axis represents frequency domain resources, e.g., in units of RBs and/or RBGs.

Referring to FIG. 19A, in slot 20, the host O-DU and the slave O-DU predict the time-frequency resource occupancy from the remaining BO. At this time, the host O-DU only occupies slots 20-23. The slots 24, the first 11 symbols of slot 25, and slots 26-27 may be slot or symbol off for energy saving, but the time domain resources of the slave O-DU are full, so the O-RU determines the intersection of the energy saving configurations of the host O-DU and the slave O-DU (e.g., takes the intersection of the energy saving configurations of the host O-DU and the slave O-DU) will not perform the energy saving configuration. The frequency domain resources at this time are not fully occupied.

Referring to FIG. 19B, in slot 20, the host O-DU reconfigures/re-allocates the time-frequency resources of all O-DUs, adjusting the time-frequency resources of all O-DUs. The true scheduling in each of slots 20-29 refers to the adjusted time-frequency resources. In slot 30, the host O-DU and the slave O-DU predict a frequency resource occupancy bitmap based on the remaining BO prediction and the frequency domain resources of the last reconfiguration period. As a result of this prediction, the host O-DU may perform slot or symbol off energy saving in slot 38 and the first 11 symbols of slot 39, the slave O-DU may perform slot or symbol off energy saving in slots 34-38 and the first 11 symbols of slot 39, and the O-RU will perform slot or symbol off energy savings in slot 38 and the first 11 symbols of slot 39 after the energy savings configuration of the host O-DU and the slave O-DU intersect. However, the energy saving efficiency at this time is low.

Referring to FIG. 19C, in slot 30, the host O-DU reconfigures/re-allocates the time-frequency resources of all O-DUs, and the time-frequency resources of all O-DUs are adjusted. At this time, the O-RU may perform slot or symbol off energy saving in slots 34-38 as well as the first 11 symbols of slot 39, improving energy saving efficiency.

In some implementation, the inputs to the AI/ML model may include one or more of the following: SU/MU MIMO related measurements, uplink and/or downlink data volume between O-CU-UP and O-DU, O-RU capability (supported sleep mode), information regarding energy consumption of the O-RU, etc.

In some implementation, the input to the AI/ML model may include one or more of the following: selection of sleep mode and its configuration, etc.

Types of AI models to which various embodiments of the disclosure relate may include at least one of the following: Perceptron, Feed-Forward Neural Networks, Radial Basis Function Networks, Deep Feed-Forward Networks, Recurrent Neural Networks, Long/Short-Term Memory Networks, Gated Recurrent Units, Autoencoders, Variative Autoencoders, Denoising Autoencoders, Sparse Autoencoders, Markov Chains, Hough Networks, Boltzmann Machines, Restricted Boltzmann Machines, Deep Belief Networks, Deep Convolutional Networks, Deep Convolutional Inverse Graphics Networks, Generative Adversarian Networks, Liquid Machines, Extreme Learning Machines, Echo-State Networks, Deep Residual Networks, Kohonen Networks, Support Vector Machines, Neural Turing, and/or the like. The AI model may be trained in any suitable training manner, such as supervised training, unsupervised training, and/or the like.

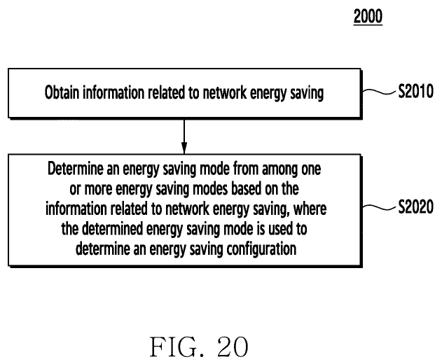

FIG. 20 illustrates a flow diagram of a method 1700 performed by a network node according to an embodiment of the disclosure. The network node may be implemented as a terminal, a base station, a Non-RT RIC, a Near-RT RIC or a combination of one or more of any of the entities described above (e.g., the entities described in connection with FIG. 1A).

Referring to FIG. 20, in operation S2010, the network node obtains information related to network energy saving.

Next, in operation S2020, the network node determines an energy saving mode from among one or more energy saving modes based on the information related to network energy saving, where the determined energy saving mode is used to determine an energy saving configuration.

In some implementations, one or more of operations S2010 to S2020 may be performed based on a method of various embodiments of the disclosure (e.g., one or more of the embodiments described in connection with FIGS. 1A to 1E, 2 to 10, 11A, 11B, 12 to 18 and 19A to 19C).

In some implementations, method 2000 may omit one or more of operations S2010 to S2020, or may include additional operations, such as operations that may be performed by a suitable network node according to various embodiments of the disclosure (e.g., one or more of the embodiments described in conjunction with FIGS. 1A to 1E, 2 to 10, 11A, 11B, 12 to 18 and 19A to 19C).

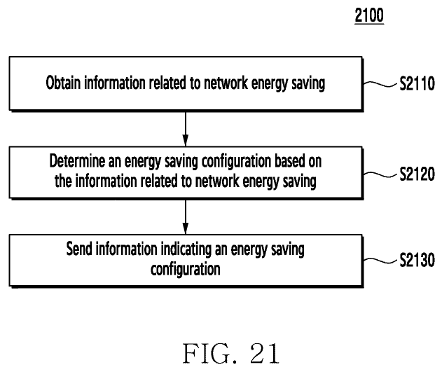

FIG. 21 illustrates a flow diagram of a method 2100 performed by a network node according to an embodiment of the disclosure. The network node may be implemented as a terminal, a base station, a Non-RT RIC, a Near-RT RIC, or a combination of one or more of any of the entities described above (e.g., the entities described in connection with FIGS. 1A through 1E).

Referring to FIG. 21, in operation S2110, the network node obtains information related to network energy saving.

Next, in operation S2120, the network node determines an energy saving configuration based on the information related to network energy saving.

Then, in operation S2130, the network node transmits information indicating the energy saving configuration.

In some implementations, one or more of operations S2110 to S2130 may be performed based on a method of various embodiments of the disclosure (e.g., one or more of the embodiments described in connection with FIGS. 1A to 1E, 2 to 10, 11A, 11B, 12 to 18 and 19A to 19C).

In some implementations, method 2100 may omit one or more of operations S2110 to S2130, or may include additional operations, such as operations that may be performed by a suitable network node according to various embodiments of the disclosure (e.g., one or more of the embodiments described in conjunction with FIGS. 1A to 1E, 2 to 10, 11A, 11B, 12 to 18 and 19A to 19C).

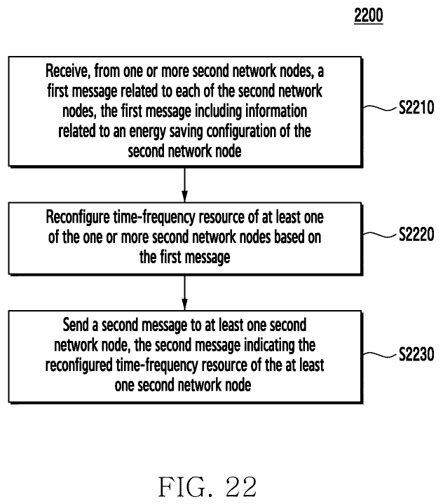

FIG. 22 illustrates a flow diagram of a method 2200 performed by a first network node according to an embodiment of the disclosure.

Referring to FIG. 22, in operation S2210, the first network node receives, from one or more second network nodes, a first message related to each of the second network nodes, the first message including information regarding an energy saving configuration of the second network node.

Next, in operation S2220, based on the first message, the first network node reconfigures/re-allocates time-frequency resources of at least one of the one or more second network nodes.

Then, in operation S2230, the first network node transmits a second message to the at least one second network node, the second message indicating the reconfigured/re-allocated time-frequency resources of the at least one second network node.

In some implementation, the first network node includes a host O-DU and the second network node includes a slave O-DU, where the host O-DU and the slave O-DU are associated with a same O-RU.

In some implementations, one or more of operations S2210 to S2230 may be performed based on a method of various embodiments of the disclosure (e.g., one or more of the embodiments described in connection with FIGS. 1A to 1E, 2 to 10, 11A, 11B, 12 to 18 and 19A to 19C).

In some implementations, method 2200 may omit one or more of operations S2210 to S230, or may include additional operations, such as operations that may be performed by the first network node as described according to various embodiments of the disclosure (e.g., one or more of the embodiments described in connection with FIGS. 1A to 1E, 2 to 10, 11A, 11B, 12 to 18 and 19A to 19C).

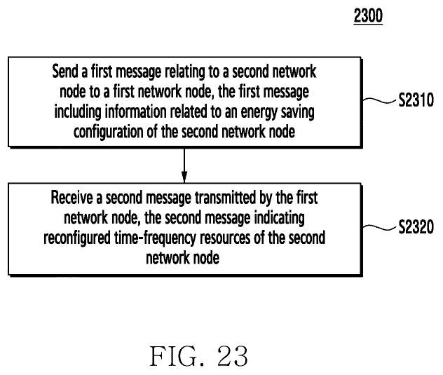

FIG. 23 illustrates a flow diagram of a method 2300 performed by a second network node according to an embodiment of the disclosure.

Referring to FIG. 23, in operation S2310, the second network node transmits, to the first network node, a first message related to the second network node, the first message including information regarding an energy saving configuration of the second network node.

Next, in operation S2320, the second network node receives a second message transmitted by the first network node, the second message indicating reconfigured/re-allocated time-frequency resources of the second network node.

In some implementation, the first network node includes a host O-DU and the second network node includes a slave O-DU, where the host O-DU and the slave O-DU are associated with asame O-RU.

In some implementations, one or more of operations S2310 to S2320 may be performed based on a method of various embodiments of the disclosure (e.g., one or more of the embodiments described in connection with FIGS. 1A to 1E, 2 to 10, 11A, 11B, 12 to 18 and 19A to 19C).

In some implementations, method 2300 may omit one or more of operations S2310 to S2320, or may include additional operations, such as operations that may be performed by a second network node as described according to various embodiments of the disclosure (e.g., one or more of the embodiments described in connection with FIGS. 1A to 1E, 2 to 10, 11A, 11B, 12 to 18 and 19A to 19C).

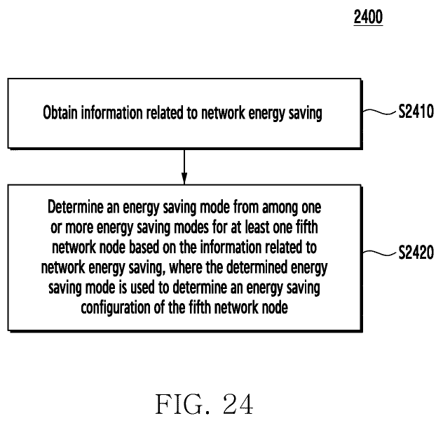

FIG. 24 illustrates a flow diagram of a method 2400 performed by a third network node according to an embodiment of the disclosure.

Referring to FIG. 24, in operation S2410, the third network node obtains information related to network energy saving.

Next, in operation S2420, the third network node determines an energy saving mode for at least one fifth network node from among one or more energy saving modes based on the information related to network energy saving, where the determined energy saving mode is used to determine an energy saving configuration of the fifth network node.

In some implementation, the third network node includes one or more of a Non-RT RIC of a SMO or a Near-RT RIC of an O-RAN.

In some implementation, the fourth network node includes an O-RU.

In some implementation, the fifth network node includes an E2 node or an O-DU.

In some implementations, one or more of operations S2410 to S2420 may be performed based on a method of various embodiments of the disclosure (e.g., one or more of the embodiments described in connection with FIGS. 1A to 1E, 2 to 10, 11A, 11B, 12 to 18 and 19A to 19C).

In some implementations, method 2400 may omit one or more of operations S2410 to S2420, or may include additional operations, such as operations that may be performed by a third network node as described according to various embodiments of the disclosure (e.g., one or more of the embodiments described in connection with FIGS. 1A to 1E, 2 to 10, 11A, 11B, 12 to 18 and 19A to 19C).

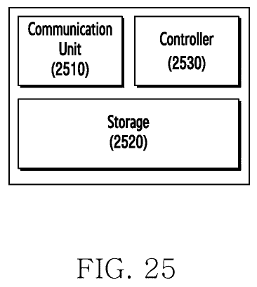

FIG. 25 illustrates a configuration of an apparatus according to an embodiment of the disclosure. The network node may be implemented as a terminal, a base station, a Non-RT RIC, a Near-RT RIC, or any combination of one or more of the entities described above (e.g., the entities described in connection with FIGS. 1A through 1E). Terms such as “˜unit”, “˜node”, “˜entity”, “˜function”, or “˜apparatus” used herein may mean a unit for processing at least one function or operation, and may be implemented using hardware, software, or a combination of hardware and software.

Referring to FIG. 25, the apparatus includes a communication unit 2510, a storage 2520 (e.g., memory), and a controller 2530.

The communication unit 2510 provides an interface for communication with other apparatus in the network. That is, the communication unit 2510 converts a bit string transmitted from this apparatus to another apparatus into a physical signal, and converts a physical signal received from another apparatus into a bit string. That is, the communication unit 2510 may transmit and receive a signal. Accordingly, the communication unit 2510 may be referred to as a modem, a transmitter, a receiver, or a transceiver. For example, the communication unit 2510 enables the apparatus to communicate with other apparatus or systems via a connection (e.g., wired backhaul or wireless backhaul) or over a network.

The storage 2520 stores data such as basic programs for the operation of the apparatus, application programs, and configuration information. The storage 2520 may include volatile memory, non-volatile memory, or a combination of volatile and non-volatile memory. The storage 2520 may provide stored data according to a request of the controller 2530.

The controller 2530 controls the general operation of the apparatus. For example, the controller 2530 transmits and receives a signal through the communication unit 1310. Further, the controller 2530 records data in the storage 2520, and reads data from the storage 2520. To this end, the controller 2530 may include at least one processor. According to various embodiments, the controller 2530 may be configured to control the apparatus to perform operations according to various embodiments described in the disclosure.

Those skilled in the art will understand that the above illustrative embodiments are described herein and are not intended to be limiting. It should be understood that any two or more of the embodiments disclosed herein may be combined in any combination. Furthermore, other embodiments may be utilized and other changes may be made without departing from the spirit and scope of the subject matter presented herein. It will be readily understood that aspects of the disclosure as generally described herein and shown in the drawings may be arranged, replaced, combined, separated and designed in various different configurations, all of which are contemplated herein.

Those skilled in the art will understand that the various illustrative logic blocks, modules, circuits, and steps described in this application may be implemented as hardware, software, or a combination of both. To clearly illustrate this interchangeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described function sets in different ways for each specific application, but such design decisions should not be interpreted as causing a departure from the scope of this application.

The various illustrative logic blocks, modules, and circuits described in this application may be implemented or performed by a general purpose processor, a Digital Signal Processor (DSP), an Application Specific Integrated Circuit (ASIC), a Field Programmable Gate Array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, multiple microprocessors, one or more microprocessors cooperating with a DSP core, or any other such configuration.

The steps of the method or algorithm described in this application may be embodied directly in hardware, in a software module executed by a processor, or in a combination thereof. The software module may reside in a RAM memory, a flash memory, a ROM memory, an EPROM memory, an EEPROM memory, a register, a hard disk, a removable disk, or any other form of storage medium known in the art. A storage medium is coupled to a processor to enable the processor to read and write information from/to the storage medium. In an alternative, the storage medium may be integrated into the processor. The processor and the storage medium may reside in an ASIC. The ASIC may reside in a terminal. In an alternative, the processor and the storage medium may reside in a terminal as discrete components.

In one or more designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that may be accessed by a general purpose or special purpose computer.

In embodiments, a method performed by a first network node in a communication system is provided. The method comprises receiving, from one or more second network nodes, a first message related to each of the one or more second network nodes, the first message including information regarding an energy saving configuration of each of the one or more second network nodes; reconfiguring, based on the first message, time-frequency resources of at least one of the one or more second network nodes; and sending a second message to the at least one of the one or more second network nodes, the second message indicating the reconfigured time-frequency resources of the at least one of the one or more second network nodes.

For example, the reconfiguring of the time-frequency resources of the at least one of the one or more second network nodes based on the first message includes reconfiguring the time-frequency resources of the at least one of the one or more second network nodes in case that an energy saving mode of the at least one of the one or more second network nodes is a predetermined energy saving mode.

For example, the receiving of the first message related to each of the second network nodes from the one or more second network nodes includes: in case that an energy saving mode of the first network node is a predetermined energy saving mode and/or the first network node and the at least one of the one or more second network nodes are associated with a fourth network node, sending a third message to the one or more second network nodes, wherein the third message is used to instruct each of the one or more second network nodes to report the first message related to each of the second network nodes; and receiving, from the at least one of the one or more second network nodes, the first message related to the at least one of the one or more second network nodes.

For example, the third message includes information indicating a period or a time interval for reconfiguring time-frequency resources of each of the one or more second network nodes. The third message includes information indicating a period or a time interval for each of the one or more second network nodes to report the first message related to the second network node.

For example, the energy saving mode of the first network node is configured by a third network node.

For example, the third network node includes one or more of a non-real-time radio access network intelligence controller (Non-RT RIC) of a service management and orchestration (SMO) or a near-real-time radio access network intelligence controller (Near-RT RIC) of an open radio access network (O-RAN).

For example, the predetermined energy saving mode includes an energy saving mode for a time unit. The time unit includes at least one of one or more symbols, one or more slots, one or more subframes, or one or more radio frames.

For example, the predetermined energy saving mode includes an advanced sleep mode (ASM).

For example, the information regarding the energy saving configuration includes at least one of information regarding an energy saving mode; information regarding a traffic priority of the one or more second network nodes; information regarding a buffer occupancy (BO) per traffic type of the one or more second network nodes; information regarding time-frequency resources of a remaining BO of the one or more second network nodes; information regarding time-frequency resources of a reference signal of the one or more second network nodes; or information regarding a bandwidth of the one or more second network nodes.

For example, the information regarding the time-frequency resources of the reference signal of the one or more second network nodes includes a time-frequency resource bitmap of a first reference signal of the one or more second network nodes, and a time-frequency resource bitmap of a second reference signal of the one or more second network nodes within each period or each time interval. The information regarding the BO per traffic type of the one or more second network node include information regarding a BO per traffic type of the one or more second network nodes within each period or each time interval.

For example, the first reference signal includes a synchronization signal block (SSB). The second reference signal includes a channel state information reference signal (CSI-RS).

For example, the reconfiguring of the time-frequency resources of the at least one of the one or more second network nodes including reconfiguring the time-frequency resources of the at least one of the one or more second network nodes based on at least one of no change for time-frequency resource positions of a reference signal; a bandwidth of the reconfigured time-frequency resources being less than or equal to a maximum bandwidth of the one or more second network nodes; minimizing a time-domain resource occupancy; ensuring a transmission of a higher priority traffic preferentially over a lower priority traffic; or reconfiguring time-frequency resources for a lower priority traffic preferentially over a higher priority traffic.

For example, the method comprises receiving a response message from the at least one of the one or more second network nodes indicating whether the reconfiguring of the time-frequency resources is successful.

For example, the first network node includes a host O-RAN distribution unit (O-DU). The one or more second network nodes include a slave O-DU. The host O-DU and the slave O-DU are associated with a same O-RAN radio unit (O-RU).

For example, the host O-DU and the slave O-DU being associated with the same O-RU includes the host O-DU and the slave O-DU share a same carrier of a same O-RU; or the host O-DU and the slave O-DU share different carriers of a same O-RU.

For example, the method comprises sending, to a fourth network node associated with the first network node and the one or more second network nodes, an energy saving configuration including information indicating one or more time units that are switched off. The time unit includes at least one of one or more symbols, one or more slots, one or more subframes, or one or more radio frames.

For example, the first network node includes a host O-DU. The one or more second network nodes include a slave O-DU. The fourth network node includes an O-RU.

In embodiments, a method performed by a second network node in a communication system is provided. The method comprises sending, to a first network node, a first message related to a second network node, the first message including information regarding an energy saving configuration of the second network node; and receiving a second message transmitted by the first network node, the second message indicating reconfigured time-frequency resources of the second network node.

In embodiments, a first network node in a communication system is provided. The first network node comprises a transceiver; one or more processors coupled to the transceiver; and memory coupled with the one or more processors and storing one or more computer programs including computer-executable instructions that, when executed by the one or more processors of the first network node, cause the first network node to receive, from one or more second network nodes, a first message related to each of the one or more second network nodes, the first message including information regarding an energy saving configuration of each of the one or more second network nodes, reconfigure, based on the first message, time-frequency resources of at least one of the one or more second network nodes, and send a second message to the at least one of the one or more second network nodes, the second message indicating the reconfigured time-frequency resources of the at least one of the one or more second network nodes.

For example, the instructions, when executed by the one or more processors of the first network node, cause the first network node to reconfigure the time-frequency resources of the at least one of the one or more second network nodes in case that an energy saving mode of the at least one of the one or more second network nodes is a predetermined energy saving mode.

For example the instructions, when executed by the one or more processors of the first network node, cause the first network node to in case that an energy saving mode of the first network node is a predetermined energy saving mode and the first network node and the at least one of the one or more second network nodes are associated with a fourth network node, transmit a third message to the one or more second network nodes, wherein the third message is used to instruct each of the one or more second network nodes to report the first message related to each of the second network nodes; and receive, from the at least one of the one or more second network nodes, the first message related to the at least one of the one or more second network nodes.

For example, the third message includes information indicating a period or a time interval for reconfiguring time-frequency resources of each of the one or more second network nodes and information indicating a period or a time interval for each of the one or more second network nodes to report the first message related to the second network node.

For example, the energy saving mode of the first network node is configured by a third network node. The third network node includes one or more of a non-real-time radio access network intelligence controller (Non-RT RIC) of a service management and orchestration (SMO) or a near-real-time radio access network intelligence controller (Near-RT RIC) of an open radio access network (O-RAN).

For example, the information regarding the energy saving configuration includes at least one of information regarding an energy saving mode; information regarding a traffic priority of the one or more second network nodes; information regarding a buffer occupancy (BO) per traffic type of the one or more second network nodes; information regarding time-frequency resources of a remaining BO of the one or more second network nodes; information regarding time-frequency resources of a reference signal of the one or more second network nodes; or information regarding a bandwidth of the one or more second network nodes.

For example, the information regarding the time-frequency resources of the reference signal of the one or more second network nodes includes a time-frequency resource bitmap of a first reference signal of the one or more second network nodes, and a time-frequency resource bitmap of a second reference signal of the one or more second network nodes within each period or each time interval. The information regarding the BO per traffic type of the one or more second network node include information regarding a BO per traffic type of the one or more second network nodes within each period or each time interval. The first reference signal includes a synchronization signal block (SSB). The second reference signal includes a channel state information reference signal (CSI-RS).

For example, the instructions, when executed by the one or more processors of the first network node, cause the first network node to reconfigure the time-frequency resources of the at least one of the one or more second network nodes based on at least one of no change for time-frequency resource positions of the a reference signal; a bandwidth of the reconfigured time-frequency resources being less than or equal to a maximum bandwidth of the one or more second network nodes; minimizing a time-domain resource occupancy; ensuring a transmission of a higher priority traffic preferentially over a lower priority traffic; or reconfiguring time-frequency resources for a lower priority traffic preferentially over a higher priority traffic.

For example, the instructions, when executed by the one or more processors of the first network node, cause the first network node to receive a response message from the at least one of the one or more second network nodes indicating whether the reconfiguring of the time-frequency resources is successful. The first network node includes a host O-RAN distribution unit (O-DU). The one or more second network nodes include a slave O-DU. The host O-DU and the slave O-DU are associated with a same O-RAN radio unit (O-RU).

In embodiments, a second network node in a communication system is provided. The second network node comprises a transceiver; one or more processors coupled to the transceiver; and memory coupled with the one or more processors and storing one or more computer programs including computer-executable instructions that, when executed by the one or more processors of the second network node, cause the second network node to send, to a first network node, a first message related to a second network node, the first message including information regarding an energy saving configuration of the second network node, and receive a second message transmitted by the first network node, the second message indicating reconfigured time-frequency resources of the second network node.

In embodiments, one or more non-transitory computer-readable storage media is provided. The one or more non-transitory computer-readable storage media stores one or more computer programs including computer-executable instructions that, when executed by one or more processors of a first network node, cause the first network node to perform operations, the operations comprising receiving, from one or more second network nodes, a first message related to each of the second network nodes, the first message including information regarding an energy saving configuration of the second network node; reconfiguring, based on the first message, time-frequency resources of at least one of the one or more second network nodes; and sending a second message to the at least one of the one or more second network nodes, the second message indicating the reconfigured time-frequency resources of the at least one of the one or more second network nodes.

In embodiments, one or more non-transitory computer-readable storage media is provided. The one or more non-transitory computer-readable storage media stores one or more computer programs including computer-executable instructions that, when executed by one or more processors of a second network node, cause the second network node to perform operations, the operations comprising sending, to a first network node, a first message related to a second network node, the first message including information regarding an energy saving configuration of the second network node; and receiving a second message transmitted by the first network node, the second message indicating reconfigured time-frequency resources of the second network node.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a first distributed unit (DU) connected to a radio unit (RU) in a communication system, the method comprising:
transmitting, to a second DU connected to the RU, a request message including information on a report period;
receiving, from a second DU, a response message in accordance with the report period, the response message including information on time-frequency resources for a buffer occupancy (BO) of the second DU;
obtaining time-frequency resources for a BO of the first DU;
determining whether to reconfigure the time-frequency resources of the second DU based on a difference between a time-domain resource duration of the time-frequency resources of the first DU and a time-domain resource duration of the time-frequency resources of the second DU, and
in accordance with a determination that the time-frequency resources of the second DU is reconfigured:
reconfiguring, based on the response message, the time-frequency resources of the second DU such that a time-domain resource duration of the reconfigured time-frequency resources of the second DU within the time-domain resource duration of the time-frequency resources of the first DU, and
transmitting, to the second DU, a configuration message indicating the reconfigured time-frequency resources of the second DU.

2. The method of claim 1,
wherein the response message includes information on a maximum bandwidth for the second DU, and
wherein the determining of whether to reconfigure the time-frequency resources of the second DU comprises:
determining whether to reconfigure the time-frequency resources of the second DU based on available frequency domain resources not occupied by the time-frequency resources of the first DU and the time-frequency resources of the second DU.

3. The method of claim 2, wherein the time-frequency resources of the second DU are reconfigured by:
reducing a time-domain resource duration of the time-frequency resources of the second DU; and
increasing a frequency-domain resource occupancy of the time-frequency resources of the second DU within the maximum bandwidth.

4. The method of claim 2,
wherein the response message includes information indicating a type of an energy saving mode of the second DU among a plurality of candidate types, and
wherein, in case that the type of the energy saving mode of the second DU is a predetermined type, the time-frequency resources of the second DU is reconfigured.

5. The method of claim 4,
wherein the energy saving mode of the first DU is configured by a network node, and
wherein the network node comprises one or more of a non-real-time radio access network intelligence controller (Non-RT RIC) of a service management and orchestration (SMO) or a near-real-time radio access network intelligence controller (Near-RT RIC) of an open radio access network (O-RAN).

6. The method of claim 2, wherein the response message includes at least one of:
information regarding a traffic priority of the second DU; or
information regarding time-frequency resources of reference signals of the second DU.

7. The method of claim 6,
wherein the information regarding time-frequency resources of reference signals of the second DU comprises a time-frequency resource bitmap of a first reference signal of the second DU and a time-frequency resource bitmap of a second reference signal of the second DU,
wherein the first reference signal comprises a synchronization signal block (SSB), and
wherein the second reference signal comprises a channel state information reference signal (CSI-RS).

8. The method of claim 6, wherein the reconfiguring of the time-frequency resources of the second DU comprises reconfiguring the time-frequency resources of the second DU based on at least one of:
no change for time-frequency resource positions of the reference signals;
a bandwidth of the reconfigured time-frequency resources being less than or equal to the maximum bandwidth for the second DU;
reducing a time-domain resource duration of the reconfigured time-frequency resources;
ensuring a transmission of a higher priority traffic over a lower priority traffic; or
reconfiguring time-frequency resources for the lower priority traffic over the higher priority traffic.

9. The method of claim 1, further comprising:
receiving, from the second DU, a re-allocation response message indicating whether the reconfiguring of the time-frequency resources is successful or not, in response to the configuration message.

10. The method of claim 1,
wherein the first DU comprises a host O-RAN distribution unit (O-DU),
wherein the second DU comprises a slave O-DU, and
wherein the RU comprises O-RAN radio unit (O-RU).

11. A first distributed unit (DU) connectable to a radio unit (RU) in a communication system, the first DU comprising:
at least one transceiver;
one or more processors coupled to the at least one transceiver; and
memory storing instructions that, when executed by the one or more processors of the first DU, cause the first DU to:
transmit to a second DU connected to the RU, a request message including information on a report period,
receive, from the second DU, a response message in accordance with the report period, the response message including information on time-frequency resources for a buffer occupancy (BO) of the second DU,
obtain time-frequency resources for a BO of the first DU,
determine whether to reconfigure the time-frequency resources of the second DU based on a time-domain resource duration of the time-frequency resources of the first DU and a time-domain resource duration of the time-frequency resources of the second DU, and
in accordance with a determination to reconfigure the time-frequency resources of the second DU:
obtain information regarding reconfigure of the time-frequency resources of the second DU such that a time-domain resource duration of the reconfigured time-frequency resources of the second DU is reduced based on the time-domain resource duration of the time-frequency resources of the first DU, and
transmit, to the second DU, a configuration message indicating information regarding the reconfigured time-frequency resources of the second DU.

12. The first DU of claim 11,
wherein the response message includes information on a maximum bandwidth for the second DU, and
wherein the determining of whether to reconfigure the time-frequency resources of the second DU comprises:
determining whether to reconfigure the time-frequency resources of the second DU based on available frequency domain resources not occupied by the time-frequency resources of the first DU and the time-frequency resources of the second DU.

13. The first DU of claim 12, wherein the time-frequency resources of the second DU are reconfigured by:
reducing a time-domain resource duration of the time-frequency resources of the second DU; and
increasing a frequency-domain resource occupancy of the time-frequency resources of the second DU within the maximum bandwidth.

14. The first DU of claim 12,
wherein the response message includes information indicating a type of an energy saving mode of the second DU among a plurality of candidate types, and
wherein, in case that the type of the energy saving mode of the second DU is a predetermined type, the time-frequency resources of the second DU is reconfigured.

15. The first DU of claim 12,
wherein the energy saving mode of the first DU is configured by a network node, and
wherein the network node comprises one or more of a non-real-time radio access network intelligence controller (Non-RT RIC) of a service management and orchestration (SMO) or a near-real-time radio access network intelligence controller (Near-RT RIC) of an open radio access network (O-RAN).

16. The first DU of claim 12,
wherein the response message includes at least one of:
information regarding a traffic priority of the second DU, or
information regarding time-frequency resources of reference signals of the second DU,
wherein the information regarding time-frequency resources of reference signals of the second DU comprises a time-frequency resource bitmap of a first reference signal of the second DU and a time-frequency resource bitmap of a second reference signal of the second DU,
wherein the first reference signal comprises a synchronization signal block (SSB), and
wherein the second reference signal comprises a channel state information reference signal (CSI-RS).

17. The first DU of claim 16, wherein the instructions, when executed by the one or more processors of the first DU, cause the first DU to:
reconfigure the time-frequency resources of the second DU based on at least one of:
no change for time-frequency resource positions of the reference signals,
a bandwidth of the reconfigured time-frequency resources being less than or equal to the maximum bandwidth for the second DU,
reducing a time-domain resource duration of the reconfigured time-frequency resources,
ensuring a transmission of a higher priority traffic preferentially over a lower priority traffic, or
reconfiguring time-frequency resources for a lower priority traffic preferentially over a higher priority traffic.

18. The first DU of claim 16, wherein the instructions, when executed by the one or more processors of the first DU, cause the first DU to receive, from the second DU, a response message indicating whether the reconfiguring of the time-frequency resources is successful, in response to the configuration message.

19. The first DU of claim 1,
wherein the first DU comprises a host O-RAN distribution unit (O-DU),
wherein the second DU comprises a slave O-DU, and
wherein the RU comprises O-RAN radio unit (O-RU).

20. A near-real time radio access network controller (Near-RT RIC) in a communication system, the Near-RT RIC comprising:
at least one transceiver;
one or more processors coupled to the at least one transceiver; and
memory storing instructions that, when executed by the one or more processors of the first DU, cause the Near-RT RIC to:
receive, from a first distributed unit (DU) connected to a radio unit (RU), information on time-frequency resources for a buffer occupancy (BO) of the first DU,
receive, from a second DU connected to the RU, information on time-frequency resources for a BO of the second DU,
determine whether to reconfigure the time-frequency resources of the second DU based on a difference between a time-domain resource duration of the time-frequency resources of the first DU and a time-domain resource duration of the time-frequency resources of the second DU, and
in accordance with a determination that the time-frequency resources of the second DU is reconfigured:
reconfigure the time-frequency resources of the second DU such that a time-domain resource duration of the reconfigured time-frequency resources of the second DU within the time-domain resource duration of the time-frequency resources of the first DU, and
transmit, to the second DU, a configuration message indicating the reconfigured time-frequency resources of the second DU.
